(19) United States
(12) Patent Application Publication
(10) Pub. No.: US 2007/0159107 A1
(43) Pub. Date: Jul. 12, 2007

(54) Apparatus and method for controlling discharge lights

(76) Inventor: David John Powell, Darbyshire (GB)

Correspondence Address: SMITH-HILL AND BEDELL, P.C., 16100 NW CORNELL ROAD, SUITE 220, BEAVERTON, OR, 97006, US

(21) Appl. No.: 10/596,821

(22) PCT Filed: Dec. 24, 2004
(86) PCT No.: PCT/GB04/05413

§ 371 Date: Aug. 23, 2006

(30) Foreign Application Priority Data
Dec. 24, 2003 (GB) 0330019.1

(51) Int. Cl. H05B 37/02

(52) U.S. Cl. 315/149

(57) ABSTRACT

Apparatus and method for supplying AC power (e.g. from an inverter) to a discharge light via a ballast circuit formed by a resonant circuit, and controlling the frequency of the AC power signal so as to operate below the natural resonance frequency of the ballast circuit in use after the discharge light has “struck.”

The present invention relates to apparatus and methods for controlling discharge type lights, such as fluorescent lights and the like.

Discharge lights operate by causing electricity to flow between two electrodes separated by an inert gas such as argon or krypton with a small amount of a conduction element such as mercury or xenon which may be in both liquid and vapour form. Electrical conduction, through the inert gas, is instigated by supplying a voltage to the electrodes of sufficient magnitude to cause electrons to migrate through the inert gas from one electrode to another. While travelling towards the anode (positive potential) electrode, electrons will typically collide with atoms of the conduction element with sufficient kinetic energy to ionise its vapour atoms and also vapourise the elements liquid atoms, thereby producing positive ions and further free electrons within the gas. Thus, a gas plasma of positively and negatively charged particles is produced. Electrons of the plasma continue to stream towards the anode of the electrodes while the much heavier positive ions of the plasma are accelerated towards the cathode thereof. This streaming of electrical charge sustains an electrical discharge within the discharge light.

Collisions within the plasma between electrons and ionised atoms of the conducting element causes the emission of light photons from the plasma as post-collisional ions relax from an excited state (caused by collision) to a ground state. In this way, electrical energy is converted efficiently into light energy within a discharge light.

The vast majority of common or garden discharge lights take the form of fluorescent tubes as often found in homes and work places. Such fluorescent tubes employ the discharge process described above. The inert gas contained within fluorescent tubes is typically mercury. This component is caused to emit Ultra-Violet (UV) radiation as a result of the collisional process described above. A phosphorescent material coating the inner surface of the glass envelope containing the discharge plasma absorbs such UV radiation and re-emits the energy received thereby as visible light.

Once the gas within the envelope of the discharge light has been rendered conductive and thereby exists in a plasma state, subsequent conduction through the gas self-sustains the plasma. However, the initial voltage required to induce this state of conduction is typically very high and is known as the “strike” voltage. As soon as the gas within a discharge light begins to discharge, the effective electrical resistance of the now conductive plasma drops rapidly. The effective resistance of the plasma behaves as a so-called “negative resistor” so called because as the voltage across the electrodes of the lamp increases, the effective resistance of the plasma decreases thereby creating an increase in discharge current through the plasma which further lowers the effective resistance and so increases the discharge current, and so on. This would end in a maximum current for minimum resistance causing the discharge light to dramatically fail were the current not controlled in some way.

A ballast circuit is typically employed to control the current passing through the discharge light in order to mitigate the run-away effects of “negative resistance”. At its simplest, a ballast circuit comprises a simple inductor placed in series electrical connection between the power supply and the discharge light. The impedance of the inductor effectively matches changes in the load resistance of the discharge light such that changes in the effective resistance of the discharge light are compensated for by resultant changes in the impedance of the inductor. In this way the ballast circuit inductor acts as a power regulator regulating the power supplied to the discharge light.

Unfortunately, since the impedance of the ballast circuit inductor is reactive, when it draws energy from an alternating-current (AC) power source the phase of the AC current drawn thereby lags the phase of the AC voltage by 90°. Consequently, power is wasted by not matching the phase of the current and voltage of the power signal drawn by the ballast circuit and discharge light in use.

As a consequence of this inefficiency, commercial electricity suppliers have, for some time, required large consumers of power to pay an additional consumer charge for consuming power in such phase mismatched conditions. Additionally, in an attempt to reverse the aforementioned phase mismatch, most domestic discharge light fittings are supplied with a simple corrector device comprising a capacitor connected in parallel across the power input terminals of the discharge light. The reactive impedance of a capacitor exhibits phase properties which are opposite to those of an inductor, namely, current will be drawn by the capacitor at a phase 90° in advance of the voltage drawn thereby when supplied by an AC power source. Hence, an appropriate capacitor may assist in nulling the phase lag induced by the ballast circuit inductor.

Unfortunately the capacitance of a typical corrective capacitor is subject to considerable variation over time in use. It is quite normal for discharge lights such as fluorescent lights to be in service for as long as 20 years. It is highly probable that within this time period a corrective capacitor will have degraded, thereby changing the value of its capacitance, or will have failed completely. As a result, the corrective properties and purpose of the corrective capacitor C will be degraded or completely lost thereby resulting in the highly inefficient powering of the discharge light.

The traditional ballast for a fluorescent discharge light is known as an electromechanical or type ‘D’. With this type of ballast the fluorescent discharge light switching-on typically proceeds as follows. Power is applied via a ballast inductor L at the frequency of the mains power source. When the voltage is first applied to the circuit, the lamp does not initially operate. Consequently, the mains supply voltage appears across the “starter” via the inductor and the light cathodes. The “starter” consists of bimetallic contacts sealed within a small discharge bulb with inert gas filling such as argon or neon. The mains voltage causes a glow discharge within the starter which heats up the bi-metallic contacts causing them to close. This completes the circuit and allows pre-heat current to flow through the inductor and both cathodes. Since the glow discharge within the starter has now ceased the bi-metallic contacts cool down and open. Because the inductance of the inductor tries to maintain current flow (i.e. it resists changes in current), the voltage across the lamp rises rapidly and strikes the light. If it does not, the starter's contacts close again and the cycle repeats. Once the light has started, the inductor controls the current and voltage to the correct levels. The current supplied to the light under normal running conditions is enough to keep the cathode heaters hot and emitting electrons without the need for separate heater supplies. Since the lamp's running voltage is much lower than the mains voltage, there is now not enough voltage to cause the glow discharge in the starter, so it remains open circuit.

A further example of known discharge light control is the next generation of ballast called electronic or type ‘A’, so called because it uses a much more complex active control circuit made up of discrete electronic components. These work by converting the mains supply voltage into a DC supply source and then inverting this back into a high frequency AC supply by means of some form of transistorised switching circuit (an inverter). The output of this inverter stage is then driven via a much smaller high frequency ballast inductor L into the discharge light. This process is much more efficient than the type ‘D’ because electronic ballasts replace the starting and inductive elements of the conventional system. The effect is to increase the operating frequency of the ballast above the 50 or 60 Hz determined by the mains to typically to a few tens of kHz. This has two main advantages, firstly the gas in the tube does not have time to deionise between current cycles, which leads to lower power consumption. Secondly the inductor required to generate a large enough voltage to ionise (strike) the tube is smaller, and so generates less resistive losses. However, the electronic solution is more complex and has a higher initial cost, this is eventually paid back by the savings in energy over time.

Fluorescent discharge lights may be “dimmed” thereby to controllably vary the radiant power output of the fluorescent light. Current dimming methods simply vary the voltage supplied to the fluorescent discharge light via the ballast circuit associated with it thereby to reduce the total power available to the inductor of the ballast and ultimately across the fluorescent discharge light. This method requires the use of expensive extra control components/stages and delivers a generally poor dimming effect. In particular, the range of variability of the irradiated power output of the discharge light (i.e. the “dimming range”) is rather small since reducing the voltage applied to the discharge light runs the grave risk of causing plasma “drop-out” whereby the voltage becomes insufficient to maintain the plasma state within the discharge light.

The new electronic fluorescent ballast, type ‘A’, are more efficient in their ability to generate light output power for input power consumed and it is to these types that the present invention is particularly (though not exclusively) directed. All present implementations of these electronic ballasts follow the exact same principles. One of the effects that they generally all exhibit is that there is an element of the source supply AC component superimposed on the DC power signal supplied to the inverter. These fluctuations in the DC power level are subsequently delivered to a discharge light via a ballast circuit. The DC fluctuations appear as “ripples” superimposed upon each half-cycle of the AC power signal. These ripples typically produce a flickering affect in the radiant power output of the discharge light. This is most undesirable. Additionally, such variations, when present during the dimming of discharge light by reducing the voltage applied to it as discussed above, may cause the applied voltage to be momentarily insufficient to maintain the plasma state of the discharge light and thereby cause plasma “drop-out”. This is most undesirable. It is also desirable to achieve the highest possible general power to light conversion efficiency in order to facilitate the lowering of total consumed mains/national power. This is of major importance to lower international CO₂ levels.

The present invention aims to overcome at least some of the deficiencies in the prior art identified above. Compared with the traditional type ‘D’ ballast the type ‘A’ ballast achieves an improvement of some 15-20% in power consumption. The present invention aims to improve that figure by a further 10% (e.g. in basic operation mode) and greater than 25% (e.g. in active ambient light controlled mode), as shall be discussed below. In the following, a reference to “AC power signal” includes a reference to either of the AC electrical current and the AC electrical voltage signal of a power source.

The present invention in its first aspect, at its most general proposes, when supplying AC power (e.g. from an inverter) to a discharge light via a ballast circuit formed by a resonant circuit, controlling the frequency of the AC power signal so as to always operate below the natural resonance frequency of the ballast circuit in use after the discharge light has “struck”. A key aim of the invention is to maximise the efficiency with which the discharge light converts delivered electrical power into emitted/radiant light.

A beneficial consequence of operating the discharge light ballast at below-resonance frequencies is that the inductor element is forced past its saturation point and therefore effectively becomes a low resistive path to the inverter output energy. This means that the losses associated with inductor magnetisation are much reduced so saving energy that would otherwise be lost as heat. It also affects the profile of the resultant current waveform delivered to the discharge light (e.g. fluorescent light) itself. With current methods these will naturally result in close approximate sinusoidal current shapes due to the resonant action of the ballast, with the present invention in its first aspect, operation below resonant frequencies results in an increase in harmonic products of the current, and therefore this creates a more “square” wave current profile that closer matches the most efficient delivery of energy to the discharge light.

The reduction in inductor losses and improved current profile result in substantial operational power savings over current ballast implementations.

Saturation is a limitation occurring in an inductor. Initially as the current (I) through an inductor is increased the magnetic flux (ø) generated by the inductor increases in proportion to it. At some point further increases (dI) in current lead to progressively smaller increases (dø) in magnetic flux. Saturation occurs substantially at the extreme ends of B vs. H curve of the inductor where dI/dø is small or zero (B=magnetic flux density; H=magnetic field intensity).

Accordingly, in a first of its aspects, the present invention may provide a method for controlling the power delivered to a discharge light by an alternating (AC) power signal via a ballast circuit which resonates at a predetermined value of the frequency of said alternating power signal, the method including;
maintaining the value of the frequency of said alternating power signal to be always less than said predetermined value after the discharge light has struck. The frequency of the power signal is most preferably controlled to maximise the efficiency with which the discharge light converts delivered electrical power into emitted/radiant light.

Whereas existing ballast control systems operate at power signal frequencies above resonance, at which the induced voltage generated by the ballast inductor is high, so as to ensure that the power-regulating effect of the ballast inductor is optimal, known as dynamically stable, the present invention, in its first aspect, proposes the converse of this, known as dynamically unstable. Consequently, in controlling an AC power signal to a ballast circuit below the resonance frequency of that circuit the present invention, in its first aspect, is able to operate in a frequency regime in which the induced voltage generated by the ballast inductor is much reduced. Subsequent delivery of power to the discharge light from/by the ballast circuit, is rendered more efficient, however, the power-regulating effect of the ballast inductor is reduced or substantially lost as a consequence. Consequently, the method of power control may provide a power-regulating function by monitoring power delivered to the ballast circuit and/or to the discharge light from/by the ballast circuit, and/or monitoring the power consumed or radiated by the discharge light, and controlling the AC power signal (e.g. by controlling the inverter that may supply it) according to the power so monitored. The frequency of the power signal is most preferably controlled to maximise the efficiency with which the discharge light converts delivered electrical power into emitted/radiant light.

Most preferably, the method includes varying the frequency of the power signal to approach the frequency at which the discharge light enters the third discharge state, in which discharge the light enters an arc discharge condition, and controlling the power signal frequency to prevent entry into that state. It has been found that power can be very efficiently delivered to (and converted into radiation by) a discharge light when it is driven close to the frequency at which it enters the arc discharge state (the “arc frequency”). The arc frequency is typically well below the resonance frequency of the ballast circuit and the effects of the slope of the resonance profile of the ballast circuit are overshadowed by the effects of proximity of the power signal frequency to the arc frequency of the discharge light when the power signal frequency is close to the arc frequency.

It has been found that the closer the power signal frequency is to the arc frequency, the greater the power delivered to the discharge light in question. The present invention, in its first aspect, preferably varies and/or controls the frequency of the power signal so as to reduce the difference between the arc frequency and the frequency of the power signal as much as possible without ever causing the discharge light to enter the arc discharge state (i.e. at which those frequencies become equal in value). In this way the efficiency of power delivery (and conversion into radiant energy by the light) may be maximised.

Preferably, subsequent to causing the discharge light to “strike”, the method includes varying the frequency of the power signal according to a measure of the power delivered to (and/or converted by) the discharge light. The value of the frequency of the power signal is preferably controlled to decrease by successive steps towards the value of the arc frequency, and the size of successive steps is selected to be sufficiently small to avoid collapse of the plasma within the discharge light.

The method preferably includes defining a target value for the measure of the power delivered to (and/or converted by) the discharge light, and then varying the power signal frequency towards the arc frequency until the measure of the power delivered (and/or converted) to the discharge light is substantially equal to the target value. Most preferably, the method includes defining a successor such target value once a given target value is reached, the successor target value being greater than the given target value. In this way the arc frequency may be approached in controlled frequency reduction steps, each step being defined in terms of an associated power delivery (and/or conversion) target value.

Preferably, the method includes reducing the size of any increment/change in the frequency of the power signal as the power signal frequency becomes smaller (and therefore closer to the arc frequency). Most preferably, the method includes placing a limit upon the size of any such increment/change. These measures enable the method to refine the speed with which the arc frequency is approached and also better enable the method to edge more closely towards the arc frequency without causing the light to enter the arc state.

The method may include adjusting the frequency of the alternating power signal so as to maximise the proportion of the power in the power signal received by the ballast circuit which is delivered to the discharge light thereby. Preferably the method includes decreasing the frequency of the AC power signal in response to decreases in the delivered power thereby to increase the power delivered to the discharge light.

The AC power signal frequency is preferably adjusted in response to variations in the delivered (and/or converted) power so as to cause a stabilisation in delivered (or converted) power. The method may include increasing the frequency of the AC power signal in response to increases in the delivered (or converted) power, and decreasing the frequency of the AC power signal in response to decreases in the delivered power (or converted), thereby to stabilise the delivered (or converted) power.

Most preferably, changes in the signal frequency are done incrementally, and the method preferably includes incrementally changing the frequency of the AC power signal to maximise (when approaching arc frequency) or stabilise (when satisfactorily close to arc frequency) the power delivered to (and/or converted by) the discharge light, wherein the frequency increments are controlled so as to not exceed a predetermined maximum increment value selected to prevent plasma drop-out in response to an increment in said frequency.

The signal frequency may be adjusted in increments not exceeding a value of about 1.5 KHz, more preferably of about 1.0 KHZ, and more preferably of about 0.5 KHz. The aim is to avoid changing the signal frequency so rapidly as to cause a plasma drop-out to occur in the unstable plasma within the light, yet be increments of sufficient size to enable the arc frequency to be rapidly searched for after the light has struck.

Preferably, increments in the signal frequency are calculated relative to a running average of previous frequency values held by the power signal as a result of a predetermined number of preceding increments. For example, the running average may be the average of the previous N frequency values where N is an integer number from 3 and 20, preferably N=about 10. Thus, any new frequency value is preferably equal to the running average plus/minus the chosen increment. With each successive increment, the running average changes in response. The number N may be varied as one approaches the arc frequency so as to refine frequency step sizes.

The present invention also preferably includes the making of (and the responding to changes in) instantaneous measurements of various properties of the AC power supply process for controlling the AC power supply. Preferably the method includes monitoring the power delivered to (and/or converted by) the discharge light by the ballast circuit, and adjusting the alternating power signal in response to variations in that delivered power so as to stabilise the delivered (or converted) power at the light.

Preferably, after the discharge light has struck, the power signal frequency is set to a value below the resonance frequency. Subsequently, the signal frequency is preferably varied as follows in order to search for the frequency optimally close to the arc frequency:
(1) measure the power (P_{L}) delivered to (or converted: by) the discharge light by the ballast circuit: then preferably
(2) measure the power (P_{B}) of the AC signal input to the ballast circuit; then preferably
(3) calculate a target power Pᵢ (where Pᵢ=Rᵢ·P_{B}; Rᵢ<1.0; i=integer) for the value of P_{L} to be attained; then preferably
(4) reduce the signal frequency (preferably incrementally); then preferably
(5) measure the power (P_{L}) delivered to the discharge light by the ballast circuit (or converted by the discharge light); then preferably
(6) compare the result of step (5) to the target power Pᵢ—if P_{L} is less than Pᵢ then goto step (4), else
(7) determine if the discharge light is sufficiently close to the arc state: if “yes” control the signal frequency to maintain/stabilise this condition; else, increment Rᵢ to Rᵢ₊₁>Rᵢ and goto step (2).

The ratio R in step (3) is preferably initiated at a value of about 0.5, and is incremented upwards as one approaches the arc frequency (higher power delivery/conversion). Most preferably, step (4) is performed by incrementally varying the signal frequency as discussed above so as to avoid plasma drop-out in the discharge light. Preferably, if it is found in step (4) that a calculated frequency change exceeds a predetermined maximum permitted change, then the implemented change is made equal to that maximum permitted value. Most preferably, in any one, some or all of steps (1), (2) and (5), the measurement of power is performed by measuring the instantaneous value of the current delivered to (or passing through) the ballast or light, as the case may be, and the power is derived thereform using other relevant measurements (e.g. instantaneous voltage) such as would be readily apparent to the skilled person. In step (7), preferably, the closeness of the discharge light to the arc state is determined by measuring the instantaneous value of the current delivered to/through the discharge light. Generally, the higher that current, then the closer the light is to the arc state. A predetermined threshold value for the delivered current value may be used at step (7) against which instantaneously measured values may be compared when making this determination. For example, sufficient closeness may be deemed to have been reached if the current through the light is found to match or exceed the threshold value.

It is to be understood that the control apparatus described below regarding the invention in its second aspect is most preferably arranged to implement the above methods.

The method may include adjusting any one or more of the: frequency, phase, or mark/space ratio, or any other aspect of the inverter AC power signal when adjusting that signal in response to variations in the delivered power. The duration/shape of positive and/or negative polarity portions of individual cycles (e.g. a half-cycle) of the AC power signal may be separately and independently adjusted for this reason.

Since the power ultimately delivered to the discharge light by the ballast circuit is dependant upon the frequency response (e.g. resonance profile) of the ballast circuit the method preferably includes varying the (e.g. inverter) AC power signal according to the frequency response of the ballast circuit when responding to variations in the delivered power so as to cause a desired variation/stabilisation in delivered power.

Since (e.g. inverter) AC power signal frequency is close to the frequency at which the arc state occurs, increases in power signal frequency will result in a decrease in power delivered to the discharge light by the ballast circuit. Conversely decreases in frequency result in an increase in such delivered power. Preferably the method includes increasing or decreasing the frequency of the (e.g. inverter) AC power signal in response to the detection of an undesired increase or decrease respectively in the power delivered to the discharge light via the ballast circuit.

The control method means most preferably includes increasing the frequency of (e.g. for individual cycles or half-cycles of) the (e.g. inverter) AC power signal in response to increases in the delivered power, and to reduce the frequency of (e.g. for individual cycles or half-cycles of) the inverter AC power signal in response to decreases in the delivered power, thereby to stabilise the delivered power. The important distinction here is that the AC power signal is always below the natural resonance value of the ballast circuit after the light has struck.

The control method preferably includes maintaining the frequency of the (e.g. inverter) AC power signal at a value sufficiently low that during at least a part of a cycle of the power signal, the inductor means of the ballast circuit is caused to saturate (i.e. passes the extreme end of the inductor B/H curve), whereby the inductor effectively becomes a resistive element only and losses are therefore reduced. This efficiency is achieved by forcing the resonant circuit to allow the remaining (i.e. saturated) part of each half cycle of the AC power signal directly through to the fluorescent light as a substantially steady signal. This will normally cause a rapid increase in the current in the light itself that would lead to the onset of the discharge process entering into the “arc discharge” condition. This would be most disastrous as the ballast for over-current and the light be irreparably damaged. The present invention therefore preferably maintains this delicate balance between efficient power consumption and decent into the destructive “arc discharge” condition by the application of high speed feedback and predictive forecasting of change. Consequently, by operating in the sub-resonant regime the present invention, in its first aspect, most preferably enables the delivery of a substantially steady current to a discharge light, via and from a ballast circuit, over a significant but controllably variable proportion of any given cycle or half-cycle of the (e.g. inverter) AC power signal.

Preferably, the control method includes monitoring one or more selected properties of the AC power signal, or a DC signal from which the AC signal may be derived, (e.g. post-inverter circuits) including some or all of the following; voltage input to the inverter circuit where an inverter is used to generate the AC power signal from a DC power signal, voltage and/or current present within the ballast circuit, voltage and/or current delivered to the discharge light by the ballast circuit, and to derive from the monitored continuous values a measure, estimate or profile of the power delivered to the discharge light.

The selected property of the a.c. power signal may be the electrical voltage and/or current associated with that signal. The voltage/current magnitude, or amplitude, or its instantaneous value(s) may be so monitored.

The selected property is preferably the value of the electrical currents as present within the ballast circuit and/or as concurrently delivered to the discharge light.

The power control method may include comparing the values of said electrical currents and/or voltages (either individually, or as combined/summed) present within the ballast circuit and/or concurrently delivered to the discharge light, to predetermined respective reference values thereof and to derive from such comparison the (e.g. average) measure of the power delivered to the discharge light.

The predetermined reference values are preferably values of the selected properties which correspond with (and are therefore indicative of) the discharge light operating normally. These predetermined reference values may be stored within a power control means (see below) for access and use as and when required thereby.

The predetermined respective reference values are preferably values corresponding with a predetermined value of power being delivered to the discharge light.

Preferably, a reference value being a predetermined proportion, fraction or percentage of the power delivered to the ballast circuit is used which indicates the division of power as between the discharge light and the ballast circuit.

The power control method preferably includes sampling values of any of the various (e.g. inverter) AC power signal once within separate successive sampling periods, wherein each sampling period is no greater in duration than the one half of the duration of a single cycle of the AC power signal. Preferably, the sampling occurs once within each half period/cycle of the AC power signal.

Preferably the power control method includes sampling the current passing through the ballast circuit and/or the discharge light (concurrently) at a time 0.3 T into a given half-cycle of the (e.g. inverter) AC power signal, where T is the duration of that half cycle. Such sampling should preferably be performed at a point that is neither too early that it “sees” (i.e. the sample represents) predominantly the energy property in the period where the most change is occurring due to inductor magnetisation and the variable negative resistance effect of the light itself are at there greatest, and not too late that no reference is possible to the reactive effect of the resonance circuit itself. The optimal sampling time has been determined by experiment to be at a point 0.3 T into each half cycle.

A consequence of supplying AC power (e.g. inverter operation) well below resonance, as discussed above, is that the electrical current supplied to the discharge light acquires a substantially squarer waveform which results in a substantially more constant light output from the discharge light during those portions of the square waveform in which the supplied current is substantially constant (i.e. during the saturation of the ballast inductor). Furthermore, since the power monitoring and control method described above enables cycle-by-cycle adjustment of the frequency of the inverter AC power signal to the discharge light, the resultant variation in frequencies tends to reduce the overall electromagnetic interference (EMI) produced by the ballast circuit and/or discharge light in use.

The power control method may include maintaining the value of the frequency of the inverter AC power signal to be about ½ of the natural resonance frequency of the ballast circuit. This has been found by experimentation to produce the most efficient operation whilst still being able to maintain the ballast outside of the damaging arc discharge condition, this is achieved by the use of intelligent control circuits.

The present invention, in a second of its aspects, may provide a power controller for controlling the power delivered to a discharge light by an alternating (AC) power signal via a ballast circuit which resonates at a predetermined value of the frequency of said alternating power signal, including:
a power control means arranged to control the AC power signal to maintain the value of the frequency of said AC power signal to be always less than said predetermined value after the discharge light has struck.

The power control means is arranged to monitor the power delivered to the discharge light by the ballast circuit, and to adjust the AC power signal in response to variations in the delivered power so as to maximise the power delivered to the discharge light. The power controller may be arranged to adjust the frequency of the alternating power signal so as to maximise the proportion of the power in the power signal received by the ballast circuit which is delivered to the discharge light thereby.

The power controller is preferably arranged to decrease the frequency of the AC power signal in response to decreases in the delivered power thereby to increase the power delivered to the discharge light. The controller may be arranged to adjust the AC power signal frequency when responding to variations in the delivered power so as to cause a stabilisation in delivered power.

The power controller may be arranged to increase the frequency of the AC power signal in response to increases in the delivered power, and decrease the frequency of the AC power signal in response to decreases in the delivered power, thereby to stabilise the delivered power.

Most preferably the power controller is arranged to incrementally change the frequency of the AC power signal to maximise or stabilise the power delivered to the discharge light, wherein the frequency increments are controlled so as to not exceed a predetermined maximum increment value selected to prevent plasma drop-out in response to an increment in said frequency.

The power control means preferably includes power monitor means arranged to monitor the value of a selected property of the AC power signal: as input to the ballast circuit; and/or, as present within the ballast circuit; and/or, as delivered to the discharge light, and to derive from the monitored value of the selected property a measure of the power delivered to the discharge light.

Monitoring of the DC power supplied to an inverter for use in generating the AC power signal may also be done by the power monitor.

Preferably, the selected property is the value of the electrical currents and/or voltage as present within the ballast circuit and/or as concurrently delivered to the discharge light. The selected property may be the voltage and/or current.

The power monitor means is preferably arranged to compare the values of the electrical currents present within the ballast circuit and concurrently delivered to the discharge light, to predetermined respective reference values thereof and to derive from that comparison the measure of the power delivered to the discharge light.

Preferably, the predetermined respective reference values are values corresponding with a predetermined value of power being delivered to the discharge light via/by the ballast circuit.

The power monitor means is preferable arranged to sample values of the selected property of the AC power signal once within separate successive sampling periods, wherein each sampling period is no greater in duration than the one half of the duration of a single cycle of the AC power signal.

The power control means may be arranged to adjust any one or more of the frequency, amplitude, or phase of the AC power signal when adjusting that signal in response to variations in the delivered power.

The power control means is preferably operable to adjust the AC power signal according to the frequency response of the ballast circuit when responding to variations in the delivered power so as to cause a stabilisation in delivered power.

Preferably, the power control means is arranged to decrease the frequency of the AC power signal in response to decreases in the delivered power, and to increase the frequency of the AC power signal in response to increases in the delivered power, thereby to stabilise the delivered power.

Most preferably the power control means is arranged to maintain the frequency of the AC power signal at a value sufficiently low that during at least a part of a cycle of the AC power signal an inductor means of the ballast circuit is caused to saturate, whereby the inductor becomes substantially only a resistive element of the ballast circuit thereby reducing energy dissipated therein.

The power controller may be arranged to operate in conjunction with an inverter means arranged to receive a direct current (DC) power input signal and to generate the alternating (AC) power signal therefrom for powering the discharge light via a ballast circuit, and the power control means preferably then includes an inverter control means arranged to generate inverter control signals for controlling the inverter so as to control the AC power signal generated thereby.

The power controller may include the power control means and the inverter means.

The controller, or method of control, may include, when supplying start-up AC power to a discharge light via a ballast circuit, controlling the frequency of the AC power signal so as to be sufficiently above the resonance frequency of the ballast circuit that the discharge light will not strike, and reducing the signal frequency until it is sufficiently close to the resonant frequency to cause the discharge light to strike. This is particularly (but not exclusively) suited for use in powering a discharge light which does no have a heater circuit(s) for heating the electron emitter(s) of the light.

Reducing the AC power signal frequency in this way, from a high value to a sufficiently low value, amounts to a search for a value of voltage, delivered by the ballast circuit to the discharge light which is merely sufficient (i.e. just enough) to cause the discharge light to strike. The procedure takes advantage of the gentle voltage ramp associated with the ballast circuit's resonance profile at frequencies above resonant frequency. The ramp is such that the voltage across the ballast circuit, and therefore the voltage delivered across the discharge light, increases gently as the AC power signal frequency decreases towards the resonant value.

The present invention in its first aspect may include a method for controlling the power delivered to a discharge light by an alternating (AC) power signal via a ballast circuit which resonates at a predetermined value of the frequency of said alternating power signal, the method including;
controlling the frequency of the AC power signal to be greater than the predetermined value by an amount sufficient to prevent operation of the discharge light, and to subsequently reduce the frequency of the AC power signal until the discharge light becomes operational.

Consequently, rather than switching on a discharge light simply by applying a very large strike voltage thereto, being a voltage which is more than sufficient to cause the light to operate, the present invention proposes searching for a strike voltage which is merely sufficient to cause the light to operate. Clearly, this is more energy efficient. Furthermore, in gently raising the voltage output to the ballast circuit, and ultimately delivered to the discharge light, one reduces the stresses that are inevitably applied to the ballast and discharge light components when applying sharply rising high-voltage strikes as is presently done in the art.

The control method may include reducing the frequency of the inverter output signal continuously thereby sweeping through successively lower frequency values, or searching in a step-wise fashion in which the AC power signal frequency acquires a succession of separate successively lower values spaced in frequency. The spacing between successive such frequency values (i.e. the search step size) may be fixed of variable. Consequently, the actual resonance frequency of the ballast circuit is searched for when switching on the discharge light, that is to say, the frequency at which the ballast circuit resonates in its current condition.

Obviously, ballast circuit components, especially capacitors thereof, are subject to considerable variation in their capacitance during the period of time (years) a given discharge light will typically be used. Of course, changes in the value of such capacitance will change the value of the AC power signal frequency at which the ballast circuit resonates and therefore the resonance profile of the ballast circuit as a whole. Consequently, the value of AC power signal frequency sufficient to cause the ballast to deliver a voltage to a discharge light sufficient to cause the light to become operational will also tend to vary over time. Indeed, in prior art systems, where a given fixed start-up power signal frequency may have been selected initially as being sufficiently high to generate the required strike voltage at the light, a subsequent increase in the resonant frequency of the ballast circuit may render that start-up frequency so close to resonance (or even at resonance) that the strike voltage generated by the ballast circuit operating at the start-up frequency damages the ballast and may destroy the discharge light.

The above frequency searching technique inherently accounts for such variations in ballast circuit resonance frequency and provides a safety mechanism which avoids such inadvertently excessive strike voltages.

The power control method preferably includes monitoring the value of a selected property of the AC power signal: as input to the ballast circuit and/or as present within the ballast circuit; and/or as delivered to the discharge light, and halting reduction in the frequency of the AC power signal when the value of the selected property reach maximum predetermined values or a change of operating state is detected.

For example, the detection of the presence of, or a rapid rise in, current through the discharge light is indicative of the onset of a plasma discharge state and therefore of the light becoming operational.

This monitoring function is also beneficial in another possible condition of operation: that of ballast turn-on with a faulty or missing target discharge light. When no light is fitted to the ballast and a user tries to switch on a light by supplying power to the ballast, the only load is the ballast resonator. As it is preferable to operate close to resonance frequency to achieve an induced voltage high enough to strike the discharge light the current, at close to resonance frequency, is very high and the stresses on components cannot be sustained for long. Normally the light would strike and the stresses would decrease but with a missing or faulty light this would not happen. However using the present aspect of the invention, this condition may be detected as the lack of a reduction in load before maximum power is measured to have been reached. Upon detection of this condition the inverter can be safely shut down without damage.

To achieve detection of faulty or dangerous light discharge conditions, the value of the current through and/or voltage across the light is measured as the (e.g. inverter) AC power signal frequency is reduced. If any one or more of these values pass predetermined maximum values before a marked power reduction is read (NB: the strike condition causes a sudden reduction in power through the resonator path) then the fault condition can be declared.

For example, in order to prevent the frequency of the (e.g. inverter) AC power signal from approaching the resonance frequency value too closely while being reduced, with the resultant risk of damage to the ballast circuit and/or discharge light components, the power control method preferably includes monitoring of the current and/or voltage applied to the ballast circuit and/or the discharge light and halting power signal frequency reductions when the monitored voltage/current is deemed to be too high. This monitoring function protects the ballast circuit and discharge light from damage through excessive signal levels when a fault condition exists in the discharge light, or when no discharge light is actually present (unknown to the user).

The power control method may include halting such further reduction in the frequency of the a.c. power signal towards resonance frequency as discussed above when the value of the selected property either: is detected to have reached a predetermined threshold value (e.g. indicating a fault condition); or, is detected to have reached a value indicative of the discharge light being operational, whichever occurs first. Of course, subsequently, the power signal frequency is further reduced towards the frequency at which the third discharge occurs (i.e. the arc state) but these frequency reductions move the frequency further away from resonance.

Most preferably, the power control method is arranged for use in powering a discharge light which does no have a heater circuit(s) for heating the electron emitter(s) of the light.

Consequently, the power control method preferably includes controlling the inverter AC power signal to generate an alternating power signal intended solely for generating a sufficient voltage across the discharge light to cause it to operate, but which is not (or need not) be sufficient for heating the electron emitter(s) of the light which may or may not be present. A clear energy efficiency.

The power control method preferably includes the use of a processor means, such as a microprocessor, for processing software arranged to generate control signals for use in controlling the inverter AC power signal.

The power controller may be arranged to control the power delivered to a discharge light by an alternating (a.c.) power signal via a ballast circuit which resonates at a predetermined value of the frequency of said alternating power signal, including:
a power control means arranged to control the frequency of said a.c. power signal to be greater than the predetermined value by an amount sufficient to prevent operation of the discharge light, and to subsequently reduce the frequency of the a.c. power signal until the discharge light becomes operational.

Preferably, the power control means is operable to reduce the frequency of the a.c. power signal continuously thereby sweeping through successively lower frequency values.

The power control means is preferably operable to monitor the value of a selected property of the a.c. power signal either: as input to the ballast circuit; and/or as present within the ballast circuit; and/or as delivered to the discharge light, and to halt reduction in the frequency of the a.c. power signal when the value of the selected property is detected to have reached a value indicative of the discharge light being operational.

The power control means may be operable to monitor the value of a selected property of the a.c. power signal generated either: as input to the ballast circuit; or as present within the ballast circuit; or as delivered to the discharge light, and to halt reduction in the frequency of the a.c. power signal when the value of the selected property is detected to have reached a predetermined threshold value or a change of operating state is detected.

The power control means may be operable to halt reduction in the frequency of the a.c. power signal towards resonance frequency when the value of the selected property either: is detected to have reached said predetermined threshold value; or, is detected to have reached said value indicative of the discharge light being operational, whichever occurs first.

The power control means preferably includes a processor means for processing software arranged, when processed, to generate control signals for use in controlling the a.c. power signal.

The power controller may be arranged to operate in conjunction with an inverter means arranged to receive a d.c. power input signal and to generate the alternating.

(a.c.) power signal therefrom for powering the discharge light via a ballast circuit, and the power control means preferably then includes an inverter control means arranged to generate inverter control signals for controlling the inverter so as to control the a.c. power signal generated thereby.

The power controller may include the power control means and the inverter means.

The present invention in its third aspect proposes, at its most general, when delivering an alternating power signal to a discharge light via a ballast circuit, adjusting the form of the alternating power signal in response to changes in the power which occur within multiples of half-cycles thereof, the adjustments being made such that the ballast circuit delivers the desired power to the discharge light.

In a third of its aspects the present invention may provide a method for controlling the power delivered to a discharge light from a source of direct-current (DC) power, the power being delivered via a signal inverter and subsequent ballast circuit as an alternating (AC) power signal, the method including:
monitoring variations in the DC power input to the signal inverter, and varying the frequency of the alternating power signal according to detected variations in the DC power input, thereby to control variations in the power supplied to the discharge light via the ballast circuit.

Preferably the control method includes varying the frequency of the AC power signal so as to minimise variations in the power supplied (e.g. the true power) to the discharge light via the ballast circuit.

Variations in the frequency of the alternating output signal are most preferably made according to the signal response of the ballast circuit via which the alternating power signal is delivered to the light.

Most preferably, the invention in this aspect includes maintaining the AC power signal (e.g. inverter) frequency below the resonance frequency of the ballast circuit. Most preferably, the invention in this aspect includes controlling the AC power delivered to the discharge light according to the first (and any other) aspect of the invention.

The ballast circuit preferably has a signal response which resonates at a predetermined frequency of the AC power signal, and the method preferably includes varying the frequency of the AC power signal: to approach the resonance frequency when the DC power input is determined to have risen; and, to recede (e.g. as determined by operation at below resonant the frequency of the ballast circuit) from the resonance frequency when the DC power input is determined to have fallen.

The control method preferably includes determining an average value of the DC power input to the inverter over a predetermined averaging period, and to vary the frequency of the AC power signal according to a difference value being the difference between an instantaneous value of the DC power input and the average value thereof.

The control method preferably includes determining for example the fundamental oscillation period (e.g. main lowest frequency component) of the variations in the DC power input, whereby the predetermined averaging period is of a duration substantially equal to the fundamental oscillation period of the variations. The inverter control means may be arranged to determine temporal position of the lowest value (e.g. trough) of the DC power input during the oscillation period thereof, and to commence the predetermined averaging period at the temporal position so determined.

Preferably, the difference value is determined immediately prior to commencement of the generation of a given cycle of the AC power signal, and the control method preferably includes modifying the e.g. base frequency of the given cycle AC power signal according to the difference value.

The control method may include predicting a future difference value e.g. from a plurality of separate and/or a successive sequence of difference values. This method is referred to as predictive AC compensation herein and may be an independent aspect of the present invention.

A correction (change) in inverter AC power signal frequency will not immediately cause a change in power delivered to the ballast circuit and/or discharge light. The correction will appear to be ineffective and may prompt further corrections. This lag is caused by the resonant elements changing their reactance values only after several complete AC power signal cycles have occurred.

The power controller may be arranged to operate according to this method being arranged to receive a signal corresponding to the instantaneous value of the DC power supplied to the AC inverter. The use of this signal can then modify the shape and period of the inverter AC drive signal(s). The power controller may include the power control means and the inverter means.

One example of this method exploits the fact that there is always an element, even if very small, of the external mains supply AC component (50/60 Hz) within the DC power supplied to the inverter. The method preferably includes reading/sampling this signal and synchronising sampling periods to that period of the AC component within the DC signal supplied to the inverter (10 ms for 50 Hz, 8.33 mS for 60 Hz). The method preferably then includes taking multiple samples of the values of the inverter AC power output signal properties (e.g. current values and/or voltage values) for each period of the AC power output signal and storing those samples as references. An average of the total samples/readings taken within a whole AC period is preferably then calculated for use as a temporal mean reference for the next AC period of the inverter output.

In the next AC inverter output period, the signed difference between an individual recorded sample of the previous period and the mean reference is used to compensate an individual sample in the current AC period. This difference is then used to calculate the value by which the frequency of the inverter AC power supply should be compensated to achieve the closest flat power response in the delivered light power for changing input DC values. This temporal sampling shift means that the effect of inverter AC frequency and mark/space ratio changes can be seen in context of their special position in each successive source AC period. This eliminates lag effects and still allows for the necessary cycle-by-cycle corrections.

In a simple example, in order to apply a correction to, say, the 30^{th} sample in a given current period, it would be desirable to apply that correction at an earlier time (at the 20^{th} sample of that period), because the correction takes a finite time to come into effect. However, it is clearly impossible to do that, because at the time of the 20^{th} sample, the controller cannot know what the value of the 30^{th} sample will be, as it occurs later. Hence the controller uses the value (or difference value) of an earlier sample (e.g. the 30^{th} sample of the previous period) as a prediction of what the 30^{th} sample will be in the current period, and makes the correction on that basis.

More generally, this method encompasses adjusting the frequency of the power output signal based upon measurement(s) of deviation of voltage and/or current from a desired value taken at an earlier time.

Preferably, the adjustments relating to each portion or value of a given AC cycle is based on an earlier (e.g. the equivalent) portion of an earlier cycle. More preferably, the adjustment is applied in advance of the portion or value to be corrected.

In a fourth of its aspects, the present invention may provide a power controller for controlling the power delivered to a discharge light from a source of direct-current (DC) power, the power being delivered via a signal inverter and subsequent ballast circuit as an alternating (AC) power signal, the power controller including:
control means arranged to monitor variations in the DC power input to the inverter means, and to vary the frequency of the alternating power signal according to detected variations in the DC power input, thereby to control variations in the power supplied to the discharge light via the ballast circuit.

The control means is preferably arranged to vary the frequency of the AC power signal so as to minimise variations in the power supplied to the discharge light via the ballast circuit.

The ballast circuit preferably resonates at a predetermined frequency of the AC power signal, and the inverter control means is preferably arranged to vary the frequency of the AC power signal: to approach the resonance frequency when the DC power input is determined to have risen; and, to recede from the resonance frequency when the DC power input is determined to have fallen.

The control means may be arranged to determine an average value of the DC power input to the inverter over a predetermined averaging period, and to vary the frequency of the AC power signal according to a difference value being the difference between an instantaneous value of the DC power input and the average value thereof.

The control means is preferably arranged to determine the oscillation period (preferably the fundamental period) of the variations in the DC power input, whereby the predetermined averaging period is of a duration substantially equal to the aforesaid oscillation period.

The difference value is preferably determined immediately prior to commencement of the generation of a given cycle of the AC power signal, and the control means is preferably arranged to modify the frequency (e.g. base frequency) of the given cycle according to the difference value immediately prior to the generation of the given cycle.

In a fifth of its aspects, the present invention provides a method for controlling the power delivered to a discharge light in use by an alternating (AC) power signal via a ballast circuit, the method including;
monitoring the ambient illumination level in the vicinity of the light, and adjusting the frequency of said AC power signal to adjust the power delivered to, and ultimately radiated by, the light thereby to control the ambient illumination level. Preferably, the control is such as to maintain the ambient illumination level at a substantially constant value.

Preferably the ballast contains a resonant circuit element that is used to control the average power delivered to the discharge light. The power may be reduced using any scheme including; source DC level reduction, mark/space ratio reduction, inverter frequency increase or resonant cycle skipping. It may also be that several of these techniques are employed together or in sequence. The current invention uses both frequency reduction and resonant cycle skipping to achieve the best dimming range.

The method may include reversibly adjusting the (e.g. average) power delivered to the discharge light in predetermined steps or in a fully variable slope (e.g. continuously). This method may also include reversible power adjustment to a final level in which all possible stable reduction in radiated light by reduction in average power has been performed, thereby to stop all AC power being input to the lights (e.g. stop all inverter activity) and so reduce the power radiated by the light to zero.

To avoid the problem of over compensation for ambient light changes, such as when part of the light source is temporarily obscured by a momentary object, schemes for ignoring sudden changes may need to be employed. In the current aspect of the invention, this is preferably achieved by the method of reading fixed temporally spaced instantaneous ambient illumination level samples (e.g. via a suitable analog to digital converter) and employing a constant averaging technique.

This technique is adding each new such samples into a data storage device (e.g. a large digital accumulator), after each value is added a predetermined multiple of the maximum size any sample is subtracted from the whole data storage device (accumulator). By way of example; if the maximum size of the accumulator is 100,000 and the maximum size of any particular sample is 100, the accumulator is 1,000 times larger than a single sample. So every time a new sample is added a value of 1,000^{th} of the current accumulator current is subtracted, in this way a constant average is maintained. The average sample value being the accumulator size divided by 1,000. So by increasing the multiple size of the accumulator the period of average is increase and vice versa.

In a sixth of its aspects, the present invention provides a power controller for controlling the power delivered to a discharge light in use by an alternating (AC) power signal via a ballast circuit, the controller including;
Control means arranged to monitor the ambient illumination level in the vicinity of the light, and change the AC power signal to adjust the power delivered to, and ultimately radiated by, the light thereby to control the ambient illumination level. Preferably, the control is such as to maintain the ambient illumination level at a substantially constant value.

Preferably the ballast contains a resonant circuit element that is controlled by the power controller and therefore able to control the average power delivered to the discharge light. The power may be reduced using any scheme including; source DC level reduction, mark/space ratio reduction, inverter frequency increase or resonant cycle skipping. It may also be that several of these techniques are employed together or in sequence. The current aspect of the invention preferably uses both frequency reduction and resonant cycle skipping to achieve the best dimming range.

The control means is preferably arranged to reversibly adjust the (e.g. average) power delivered to the discharge light in predetermined steps or in a fully variable (e.g. continuous) slope. This may also include reversible adjustment to a final level in which all possible stable reduction in radiated light by reduction in average power has been performed, thereby to stop all AC power input to the discharge light and so reduce the power radiated by the light to zero.

The invention in any one of its aspects may be employed together with, or in combination with, the invention in any one or more of the other of those aspects.

In a further of its aspect, the present invention may provide a method as described above. In yet a further of its aspects, the present invention may provide a power controller, a ballast circuit, and/or control apparatus as described above.

Examples of the invention shall now be illustrated with reference to the accompanying drawings in which:

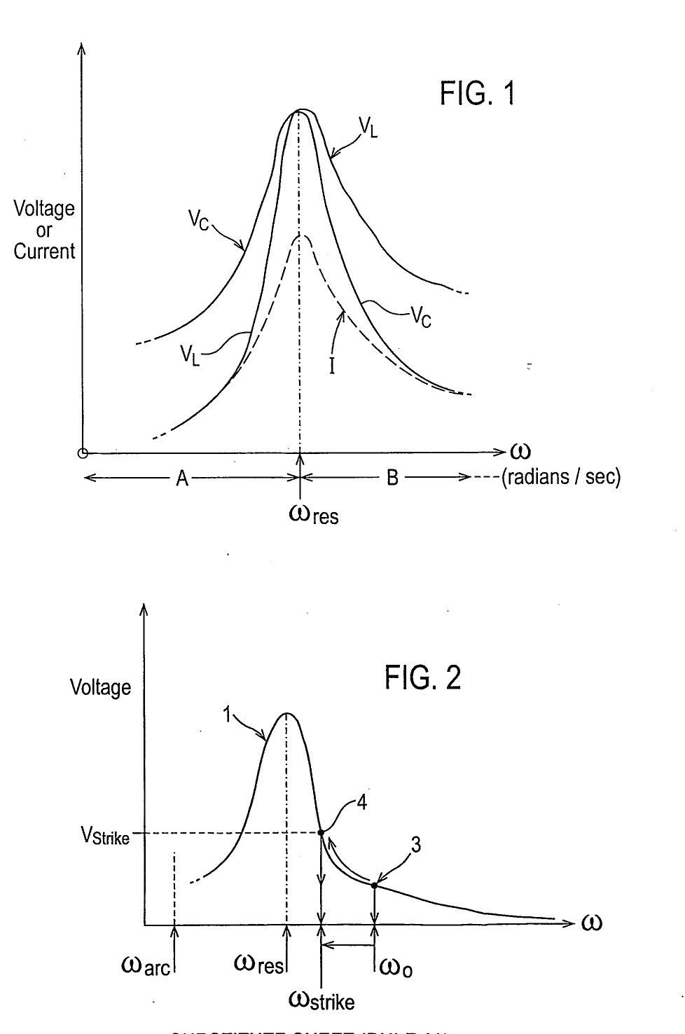

FIG. 1 schematically illustrates a typical frequency response for an LC-resonant circuit displaying a resonance profile centred upon a specific signal resonance frequency;

FIG. 2 schematically illustrates the signal response of an LC-resonant ballast circuit;

FIG. 3 illustrates schematically a signal inverter means, inverter control unit, ballast circuit and discharge light arranged in use;

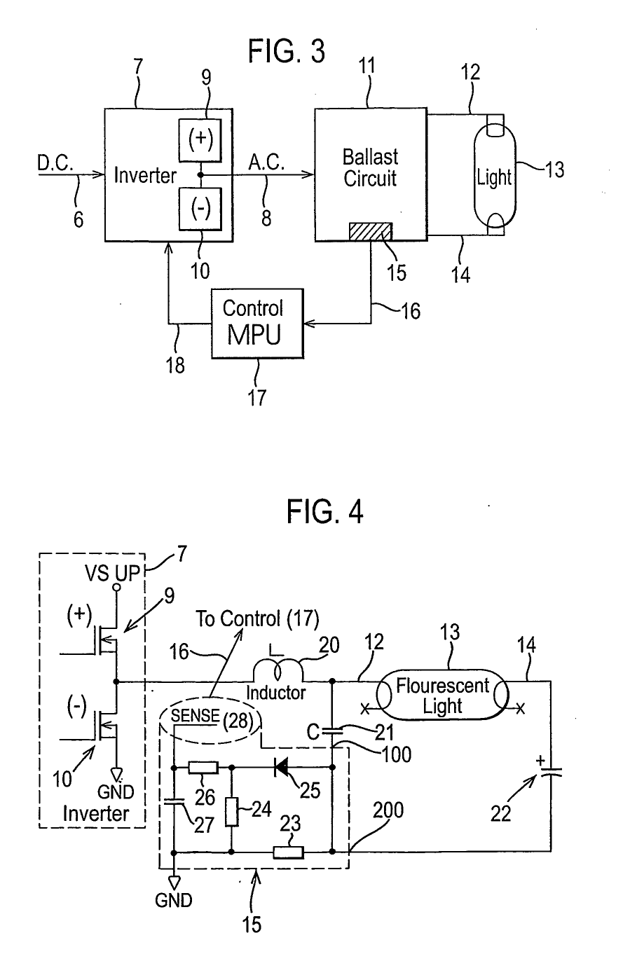

FIG. 4 schematically illustrates the inverter unit ballast circuit and discharge light of FIG. 3, together with the monitor means of the control unit of FIG. 3;

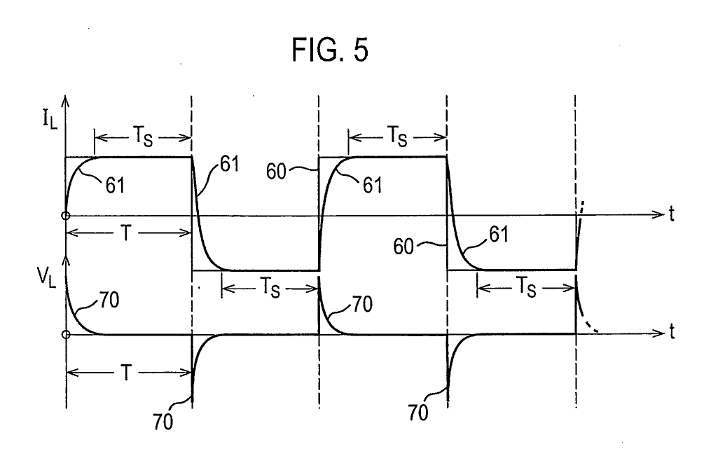

FIG. 5 schematically illustrates the waveform of electrical current passing through a ballast inductor as it reaches and passes through saturation thereof;

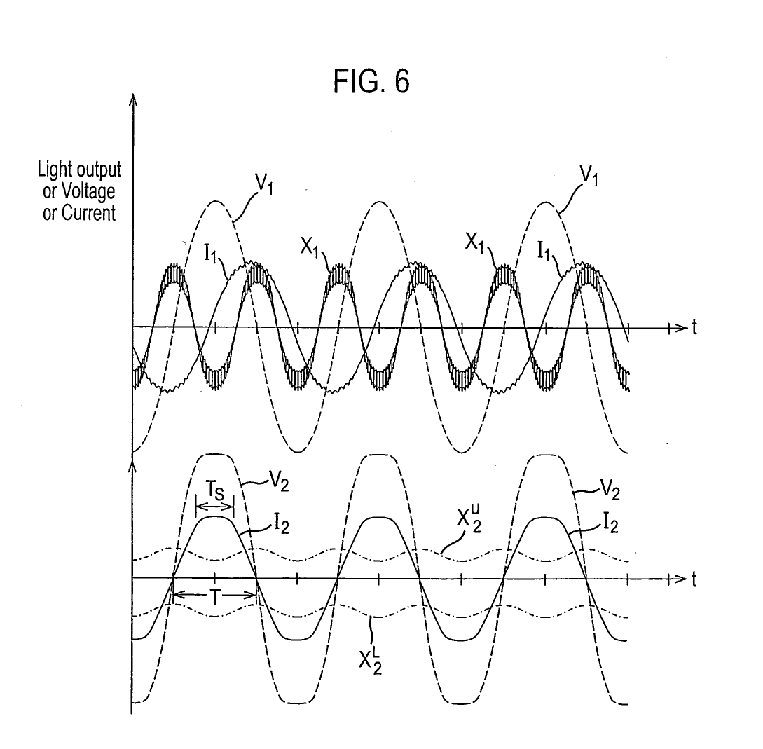

FIG. 6 illustrates supply voltage, supply current and radiate light output plots of fluorescent discharge lights;

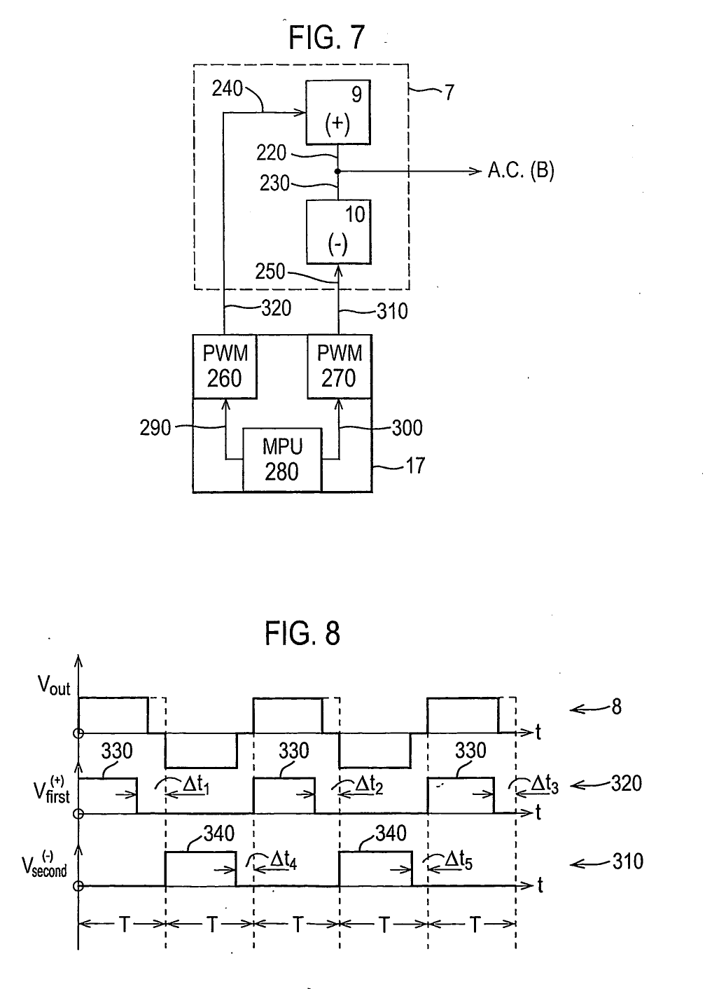

FIG. 7 illustrates a power controller and signal inverter controlled by the power controller;

FIG. 8 illustrates examples of power controller control output signals as generated by the power controller of FIG. 7, and the resultant signal inverter output signals of the signal inverter controlled thereby;

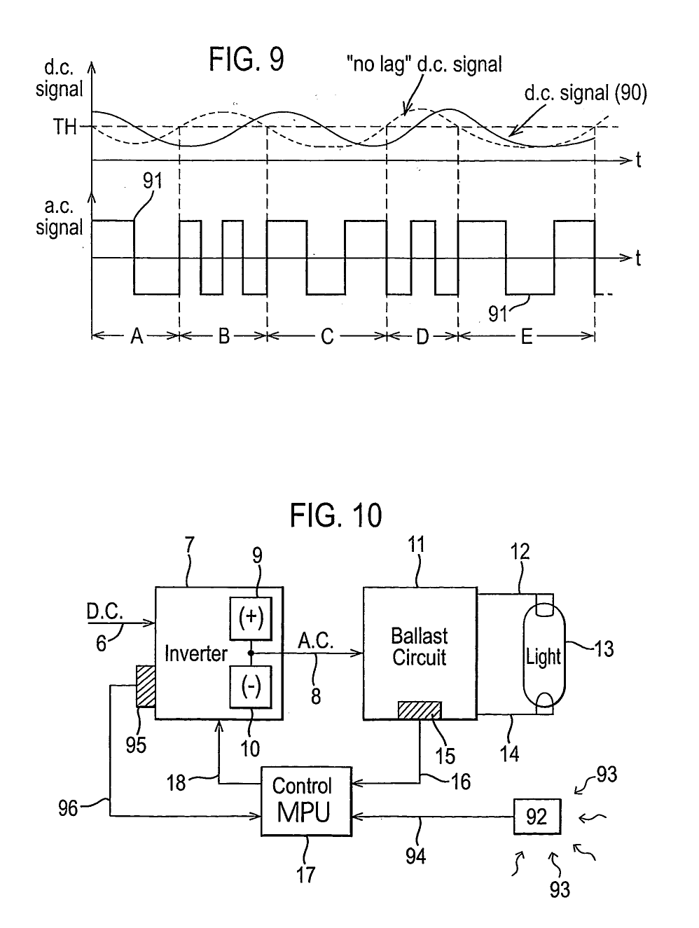

FIG. 9 illustrates the form and relative timings of periodic variations in the d.c. power input to a signal inverter from which the inverter generates an a.c. power signal, and the variation in frequency of that a.c. power signal according to the rising and falling of the varying d.c. power input;

FIG. 10 illustrates schematically a signal inverter means, inverter control unit, ballast circuit and discharge light arranged in use.

FIG. 1 schematically illustrates the frequency response of a typical series LC-resonant circuit, such as a ballast circuit. Such a circuit includes an inductor of inductance L connected in series electrical connection with a capacitor of capacitance C. Such a circuit will, in practice, typically also contain an electrical resistance R caused by components (e.g. wires) of the circuit, particularly the inductor.

It is well known that the total impedance Z of such a resonant circuit is simply the sum of the individual impedances of the resistive, inductive and capacitive components of the circuit. The resistive component is purely ohmic and therefore real, while the inductive and capacitive components are in fact reactive and imaginary. The phase of the inductive reactance leads the phase of the capacitive reactance by 180° in the complex plane. While the magnitude of the resistive component of the impedance is independent of the frequency of an electrical signal passing through the LC-resonant circuit, both the inductive and capacitive reactances are sensitively dependent upon such frequency. At low frequency values the capacitive impedance component dominates the total impedance of the circuit while at high frequency values the inductive impedance component dominates.

FIG. 1 illustrates this relationship in terms of the voltages generated across the capacitive and inductive impedance components of a typical series LC-resonant circuit. When the signal frequency ω is low (region A of FIG. 1) the rate of change of the current I passing through the inductor L is low, and consequently the induced voltage V_{L} where: (V_{L}=LdI/dt) is correspondingly low and the slowly varying current causes the voltage across the capacitor C of the circuit to be relatively large and dominant. As the signal frequency ω increases so too does the rate of change of the current I passing through the inductor L and, consequently, the induced voltage V_{L} increases, as does the voltage V_{C} across the capacitor C. These voltages continue to increase as the signal frequency ω approaches a resonant value ωᵣₑₛ at which the voltages V_{C} and V_{L} across the capacitor and inductor respectively reach a maximum value. The current I passing through the circuit also reaches a maximum value. The LC-resonant circuit resonates at this point. It is important to note that the inductor generates highly increasing voltages as the resonance area is passed is in response to the increasing rate of change of the current this increased voltage is many times greater than the DC supply value is to power the AC inverter. It is this principle that allows the high strike voltage to be achieved but is also the reason for the danger of overload in the inverter as the rate of change current reaches the limit that can be safely sourced by the inverter electronics. In practice the inverter output frequency does not pass through the resonance value as this the load would destroy the inverter.

The high frequency regime, denoted region B in FIG. 1, is entered when the signal frequency ω exceeds the resonance frequency. When this occurs, while both the inductor and capacitor voltages, V_{L} and V_{C} respectively, begin to decrease with increasing signal frequency, the voltage V_{C} across the capacitor increases more rapidly than voltage V_{L} across the inductor. Consequently, in the high-frequency regime the induced voltage generated across the inductor L dominates the voltage across the LC-resonant circuit.

FIG. 3 schematically illustrates a power controller operatively connected to a discharge light via a ballast circuit in use. Note here that in the present invention the light heaters are not used but are tied together.

A signal inverter circuit 7 is arranged to receive a DC power input signal 6 and to generate an alternating (AC) power output signal 8 therefrom for powering the discharge light 13 via the ballast circuit 11. The inverter circuit 7 includes a “high-side” signal generator circuit 9 arranged to generate the positive polarity portions of the alternating output signal 8 of the inverter, and a separate “low-side” signal generator 10 arranged to generate the negative polarity portions of the alternating output signal 8 of the inverter 7.

The form and structure of the inverter circuit 7, and its constituent “high-side” and “low-side” portions (9 and 10) may be of a type readily apparent to the skilled person and shall not be discussed in detail herein. Suffice to say that any suitable form of switching circuitry may be employed in order to alternately switch the polarity of the DC signal 6 input to the inverter circuit 7 before that signal is subsequently output from the inverter circuit. Each of the “low-side” and “high-side” circuits may comprise an appropriately arranged transistor as is illustrated in FIG. 4.

A ballast circuit 11 is arranged to receive the AC power signal 8 generated by an output from the inverter circuit 7 and to deliver power conveyed by the AC power signal to the discharge light 13 via power terminals, 12 and 14, of the discharge light. The power terminals of the discharge individually deliver current to and from the electron emitter electrodes of the discharge light in use.

The form and structure of the ballast circuit 11 of FIG. 3 may be such as would be readily apparent to the skilled person. The present embodiment uses a half bridge approach with a low impedance DC blocked floating return.

A power controller includes an inverter control means 17 and a power monitor means 15 operatively connected to, and in communication with the inverter control means 17 via a communications link 16. The inverter control unit 17 comprises a microprocessor control unit (MPU) operatively connected to and in communication with the inverter circuit 7 via a control communications link 18.

The power monitor means 15 is arranged to monitor the value of a selected property of the AC power signal 8 generated by the inverter means either/both as present within the ballast circuit 11 or/and as concurrently delivered to the discharge light 13. The power monitor 15 samples the selected property in question on every half-cycle of the inverter and delivers the sample results to the MPU control unit 17 via the communication link 16 between the power monitor and the MPU control unit. In response to the monitored values so received, the MPU control unit controls the inverter circuit 7 so as to maintain the value of the frequency of the AC output signal generated thereby so as to be below the resonance frequency value of the ballast circuit 11 when the discharge light 13 is operating (i.e. has already struck and is conducting).

Control signals generated by the MPU control unit 17 are communicated to the inverter circuit 7 via the communications link 18 connecting the former to the latter. Furthermore, the MPU control unit 17 is arranged to generate control signals for controlling the inverter circuit to adjust the frequency of the AC output signal generated thereby, these adjustments being made in response to variations in the power delivered to the discharge light so as to stabilise that delivered power as follows.

The electrical current generated by the inverter means both as present within the ballast circuit 11 and as concurrently delivered to the discharge light 13 is simultaneously sampled by the power monitor unit 15 once within each half-cycle of the alternating waveform of the AC power signal. The sampled values are communicated by the power monitor unit 15 to the MPU control unit 17 via the communications link 16 between the two. The MPU control unit compares the sampled values with pre-stored values of ballast current and concurrent discharge light current which are known to correspond to the “normal” or acceptable/desirable operation of the particular ballast circuit and discharge light in use. If this comparison indicates that the power delivered to the discharge light exceeds the desired/“normal” value, the MPU control unit generates inverter control signals which cause the inverter circuit 7 to increase the frequency towards the resonant value of the AC power signal generated thereby. Conversely, should the comparison undertaken within the MPU control unit indicate that the power delivered to the discharge light 13 is less than the desired/“normal” value, then the MPU control unit generates inverter control signals which cause the inverter circuit 7 to decrease the frequency away from the resonant value of the AC power signal generated thereby. The aforementioned control signals are communicated to the inverter circuit 7 via the communication link 18 connecting the MPU control unit to the inverter circuit.

Of course, the MPU control unit is operable to vary the AC power signal generated by the inverter circuit according to the frequency response of the ballast circuit when responding to the variations in the delivered power as discussed above. The power-stabilising effect of these variations can be understood with reference to FIG. 1.

The behaviour of a fluorescent light when driven, by a DC current, is generally linear but has the strange property of negative resistance that is to say that as power increases, the effective load resistance decreases until the 3^{rd} state of discharge is entered that of “arc discharge”. The arc condition is terminal for a fluorescent light and must therefore be avoided.

It has been found that the negative resistance slope (i.e. rate of change of load resistance with respect to power changes) changes as a function of time. All current ballast design techniques employ the same “sine” current drive as they all use a standard LC ballast circuit run at close to the resonant frequency to achieve the best stability of radiated light energy. However if the power profile is altered towards a leading sloped square wave, as per a saturating inductor, the result is different. Initially the current remains the same in the latter part of the half period but at a certain point it will suddenly rise rapidly as the plasma suddenly tries to enter the “arc discharge” phase of discharge. Just before this occurs the radiated power output of the light is increasing in a very efficient zone without a proportional increase in energy consumed. It is the task of the controller MPU to best judge this phase so as to exploit the efficiency but to avoid the onset of the arc discharge.

After the discharge light has struck, the power signal frequency is set to a value below the resonance frequency. Subsequently, the signal frequency is varied as follows in order to search for the frequency optimally close to the arc frequency:
(1) measure the power (P_{L}) delivered to the discharge light by the ballast circuit: then
(2) measure the power (P_{B}) of the AC signal input to the ballast circuit; then
(3) calculate a target power Pᵢ (where Pᵢ=Rᵢ·P_{B}; Rᵢ<1.0; i=integer) for the value of P_{L} to be attained; then
(4) reduce the signal frequency (preferably incrementally); then
(5) measure the power (P_{L}) delivered to the discharge light by the ballast circuit; then
(6) compare the result of step (5) to the target power Pᵢ—if P_{L} is less than Pᵢ then goto step (4), else
(7) determine if the discharge light is sufficiently close to the arc state: if “yes” control the signal frequency to maintain/stabilise this condition; else, increment R to Rᵢ₊₁>Rᵢ and goto step (2).

The ratio R in step (3) is initiated at a value of about 0.5, and is incremented upwards (e.g. in steps of a size between, say, 0.01 and 0.005) as one approaches the arc frequency (higher power delivery). Step (4) is performed by incrementally varying the signal frequency so as to avoid plasma drop-out in the discharge light. Thus, if it is found in step (4) that a calculated frequency change exceeds a predetermined maximum permitted change, then the implemented change is equal to that maximum permitted value. In any one, some or all of steps (1), (2) and (5), the measurement of power is performed by measuring the instantaneous value of the current delivered to the ballast or light, as the case may be, and the power is derived thereform using other relevant measurements (e.g. instantaneous voltage) such as would be readily apparent to the skilled person. In step (7), the closeness of the discharge light to the arc state is determined by measuring the instantaneous value of the current delivered to the discharge light. Generally, the higher that current, then the closer the light is to the arc state. A predetermined threshold value for the delivered current value may be used at step (7) against which instantaneously measured values may be compared when making this determination. For example, sufficient closeness may be deemed to have been reached if the current through the light is found to match or exceed the threshold value.

Changes in the signal frequency are done incrementally, and the method includes incrementally changing the frequency of the AC power signal to maximise (when approaching arc frequency) or stabilise (when satisfactorily close to arc frequency) the power delivered to the discharge light. The frequency increments are controlled so as to not exceed a predetermined maximum increment value selected to prevent plasma drop-out in response to an increment in said frequency.

The signal frequency is adjusted in increments not exceeding a value of 0.5 KHz. This avoids changing the signal frequency so rapidly as to cause a plasma drop-out to occur in the unstable plasma within the light, yet the increments are of sufficient size to enable the arc frequency to be rapidly searched for after the light has struck. Increments in the signal frequency are calculated relative to a running average of previous frequency values held by the power signal as a result of a predetermined number of preceding increments. The running average is the average of the previous 6 frequency values. Thus, any new frequency value is equal to the running average plus/minus the chosen increment.

Thus the invention in its first aspect and in this embodiment operates at below resonant frequency to allow the current profile to exploit this effect. It also means that the apparent frequency-to-radiated energy relationship is reversed. If the inverter AC drive frequency is shifted towards the resonance value the amplitude of the output signal does increase but the energy is merely focused about the centre of the half-cycle. If the frequency is lowered, instead of the expected lowering of energy due to operation further away from resonance it actually increases due to the fact that the inductor is saturated for longer and so the current profile, described above, is shifted towards the arc discharge event.

So, therefore, the energy in the light increases, as the frequency is shifted further below the resonant value, and decreases as it is moved closer to it. As the frequency is steadily decreased, however, it becomes more and more difficult to maintain control over the safe point, this sets the extreme limit for operation within this effect. The present invention preferably uses all the above described techniques to get as close to the maximum deviation, it preferably does this by trying to produce the best energy stability that is practically possible.

Referring back to FIG. 1, the inverter control unit causes the signal inverter circuit 7 to operate in the low-frequency regime (regime A of FIG. 1) in which signal frequencies are well below the resonance frequency of the ballast circuit in use, and are close to the frequency (ω_{arc}) at which the third discharge state (arc) is reached. Consequently, increases in the power delivered to the discharge light from the inverter circuit via the ballast circuit may be provided simply by decreasing the AC power signal frequency. Conversely, increasing the a.c. power signal frequency decreases the power delivered to the discharge light by the ballast circuit. This is the opposite of what would occur were the signal frequency below resonance but relatively close to the resonance profile (where significant resonance profile slope is present).

Since the frequency of the AC power signal supplied to the inductor of the ballast circuit 11 is low (and particularly because it is below the resonance frequency associated with the ballast circuit), the inductor will be caused to saturate during a portion of each half-cycle of the alternating current supplied thereto by the inverter circuit.

FIG. 5 schematically illustrates an example of an AC waveform of a current I_{L} supplied to the ballast inductor L by the inverter circuit 7, together with a waveform of the induced voltage V_{L} generated across the inductor L as a result of the waveform of the current I_{L}. In the absence of the generation of induced voltage within the inductor L of the ballast circuit 11, an alternating square-wave electrical current waveform 60 as generated by the inverter circuit 7 could, in principle, be delivered to the inductor L. However, due to the rapid variation in supplied current at the falling and rising edges of the square wave current 60, an induced voltage V_{L} is generated in direct proportion to that rate of current change. As is well known, the induced voltage opposes the change in current responsible for its own creation with the result that an otherwise sharp/step increase in current is reduced to a waveform 61 which increases exponentially at positive polarity portions of the waveform, and decreases exponentially at negative polarity portions thereof. The initially rapid exponential increase/decrease of the rising/falling edge of the waveform 61 of the delivered current I_{L} is accompanied by a sharp induced voltage spike 70 which subsequently exponentially decays as the delivered current I_{L} approaches and reaches its maximum steady-state or “saturation” value, and therefore the magnitude of the induced voltage (V_{L}) is negligible.

Thus, in the low frequency regime, below resonance frequency, one is able to drive the ballast circuit with the inductor in a saturated state during a portion T_{S} of each half-cycle period T of the inverter AC current waveform. During this saturation period a substantially constant current is supplied to the discharge light with the beneficial consequence that the light output of the discharged light will remain substantially uniform during this period and not vary as would otherwise be the case were the supplied current to continually vary.

FIG. 4 illustrates the power monitor unit 15. Like items, as between FIG. 3 and FIG. 4 have been assigned like reference symbols for the purposes of consistency. The functional and structural description of like items referred to above with reference to FIG. 3 applies equally to the corresponding items in FIG. 4.

FIG. 4, the ballast circuit 11, a ballast inductor 20 (L) capacitor 21 (C) thereby collectively forming a series LC-resonant ballast circuit. Capacitor 22 creates a low pass DC averaging for the passive half of the bridge configuration, it plays no part in the tuning of the resonant circuit.

The ballast circuit 11 and the discharge light 13 are both connected the monitor unit 15 such that the former and the latter are connected to the grounded terminal GND via the suppression filter of the monitoring unit 15. The monitoring unit has a first signal input 100 connected to the output terminal of the ballast circuit 11, this being the terminal of the capacitor C of the ballast circuit which is other than the terminal thereof connected to the ballast inductor 20. In addition, the monitoring unit has a second input 200 connected to the output terminal of the electron emitter filament 14 of the discharge light being the electrode of the discharge light not directly connected to the ballast inductor 20. Thus, the first and second input terminals, 100 and 200 respectively, of the monitor unit 15 respectively receive the electrical current concurrently output by the ballast circuit 11 and the discharge light 13 respectively.

These simultaneously received currents are mixed by the high frequency suppression filter of the monitor unit which comprises a first filter arm consisting of a diode 25 biased to prevent current flowing other than into the suppression filter along that arm, and a first resistor 26 subsequent to the diode 25. A second filter arm comprises a resistor 23 and terminates at a grounded terminal GND. A third resistor connects the first filter arm, at a point intermediate the diode 25 and the first resistor 26, to the second filter arm at a point subsequent to the second resistor 23. A filter capacitor 27 connects the terminal end of the first filter arm (subsequent to the first resistor 26) to the terminal end of the second filter arm (subsequent to the point of connection thereupon of the third resistor 24) thereby connecting the terminal ends of the first and second filter arms collectively to the same grounded terminal GND. Each filter arm is connected to both of the first and second monitor input terminal (items 100 and 200). The result is a mixing of the currents output by the ballast circuit 11 and the discharge light 13 simultaneously, the subsequent filtering of the mixed currents, and the ultimate sensing of the filtered mixed currents at a current sensor 28 operatively connected to the output of the suppression filter between the first resistor 26 of the first filter arm and the filter capacitor 27 inter connecting the first and second filter arms. The filter circuit 15 serves several purposes; firstly it creates a common total energy sense point that is sensed by the controller, secondly it allows the reference to be sensed at a ground point that is positioned close to the controller and therefore contains minimum spurious signals, thirdly it means that the sense converter process can detect in a single sample the value presented (if there where no close coupled high frequency filter then there is every chance of a noise spike being processed as the actual value, this would lead to major problems in any correction response).

Upon sensing the combined, mixed output current at the sensor 28 of the monitor unit 15, the value of the sensed current is digitised in an analogue to digital converter of the monitor unit (not shown), and the digitised sensed current value is transmitted to the MPU control unit 17 via the communication link 16 for subsequent recording, averaging and comparison with predetermined “normal” values of the combined current stored within the MPU control unit.

Exemplary Modes of Operation

Examples of a preferred mode of operation of an embodiment of the present invention (in any one or more of its aspects) shall now be described.

The nature of the voltage and current drive signals delivered to the discharge light by the ballast circuit 11 are sensitively dependent upon the nature and form of the AC signals delivered to the ballast circuit 6 by the inverter circuit 7 in use. In order to provide optimal control of the waveform of the AC signal delivered to the ballast circuit, the generation of the positive-polarity parts and the negative-polarity parts of the inverter output signal are separately and individually controlled such that opposite polarity parts may be independently formed.

Like items, as between FIG. 3, FIG. 4 and FIG. 7 have been assigned like reference symbols for the purposes of consistency. The functional and structural description of like items referred to above with reference to FIG. 3 and FIG. 4 applies equally to the corresponding items in FIG. 7.

FIG. 7 schematically illustrates the means by which such waveform control is effected. The MPU control unit 17 includes a first control signal generator in the form of a first programmable pulse-width modulator (PWM) 260 and a separate second control signal generator in the form of a second programmable pulse-width modulator (PWM) 270 each being arranged to separately generate first and second inverter control signals respectively. Each of the first and second control signal generators is programmable to exist in either an active state in which a generator output is produced thereby, or in an inactive state in which no generator output is produced thereby. The inverter controller further includes a programming unit in the form of a micro-processor unit (MPU) 280 in separate communication with each of the first and second PWMs via respective data links 290 and 300. The MPU is arranged to successively re-program each of said first and second control signal generator means so as to alternate between an active state and an inactive state. Obviously, an inverter control signal is generated according to the presence and absence of such control signal generator outputs.

The MPU control unit 17 is arranged to input the first and second inverter control signals (320 and 310 respectively) to the inverter 7 via separate respective control signal input channels 240 and 250 which collectively define the communications link 18. The high-side 9 of the inverter, responsible solely for the generation of positive-polarity parts of the inverter output, is therefore directly connected and in communication with only the first of the two separate PWM control signal generators 260. Similarly, the low-side 10 of the inverter, being responsible solely for the generation of negative-polarity parts of the inverter output, is in direct communication with only the second of the two PWM control signal generators 270.

The high-side 9 of the inverter generates a positive polarity pulse in response to the presence thereat of a first control signal pulse from the first PWM 260 and outputs the pulse at a high-side output port 220. Similarly, the low-side 10 of the inverter generates a negative polarity pulse in response to the presence thereat of a second control signal pulse from the second PWM 270 and outputs the pulse at a low-side output port 230. Concurrent outputs at the low-side and high-side output ports are combined and output as the inverter output signal 8 at any given point in time. Thus, appropriate shaping and timing of the PWM control signal pulses, and therefore of the high-side and low-side outputs of the inverter, determines the form of the inverter output.

FIG. 8 schematically illustrates an example of the relative timings of the first (V_{first}⁽⁺⁾) and second (V_{second}⁽⁻⁾) inverter control signals. While FIG. 8 illustrates relatively uniform square-wave type control pulses, it is to be understood that the first and second control inverter signals may be generated other forms in such a way as to control any of the amplitude, frequency, phase, shape or energy of any single cycle of the alternating output of the inverter means.

Each of the first and second inverter control signals comprises a train of control signal pulses as illustrated in FIG. 8. The inverter control means is arranged to generate successive control signal pulses of the two separate inverter control signals alternately such that any control signal pulse of any one such inverter control signal is present only if a control signal pulse of the other such inverter control signal is absent thereby avoiding the temporal overlap (or interference) of the former with the latter.

This is achieved by the MPU programming unit 280 which is arranged to alternately prevent one of the first PWM 260 and the second PWM 270 from generating of a control signal pulse (e.g. pulse 330 of FIG. 8) while simultaneously causing the other of the two PWMs to generate such a pulse (e.g. pulse 340 of FIG. 8). Each of the first and second PWMs is programmable between an active state in which a signal, V_{first}⁽⁺⁾ and V_{second}⁽⁻⁾ respectively, is output thereby, and an inactive state in which no signal is output thereby. The programming unit MPU 280 alternately re-programs the first and second PWMs to be either in opposite such states, or to be concurrently in an inactive state. The programming unit MPU 280 contains software programmed to assign a control period of duration T alternately to the first PWM 260 and the second PWM 270. During a given assigned control period T, one PWM is held inactive (no output) while the other PWM is programmed by the MPU to become active (output produced). However, before the given control period T expires, the software within the MPU adjusts the duration of the control period T to be a shorter control period T′=T−Δt and re-programs the currently active PWM, but not the currently inactive PWM. Consequently, at a time T′ the currently active PWM becomes inactive while the other inactive PWM remains so for a further “dead-time” time period Δt. The MPU then returns the control period to a value T and repeats the above procedure in respect of the other of the two PWMs (i.e. the two PWMs swap roles).

The result is that either a first control signal pulse 330, or a second control signal pulse 340, or no control signal pulse is generated by the inverter controller at any given time. Notably, the concurrent generation of both a first and a second control signal pulse is avoided.

The result is that the duration of control signal pulses alternately generated by the first and second PWM are controlled to provide a variable “dead-time” (Δtᵢ, i=1,2,3 . . . ) between successively generated such pulses during which no control signal pulse of either of said two separate control signals exists. Each individual dead-time may be separately chosen by the MPU 280 so as to manipulate the waveform of the control signals separately and of the alternating output 8 (waveform Vₒᵤₜ of FIG. 8) of the inverter circuit.

With this control ability it is possible to generate appropriately timed excitation pulse signals which are then input into the discharge light via the ballast circuit. The time between to successive rising edges of the high-side PWM control signal determines the frequency of the inverter AC power signal. The timing form of these PWM drive signals are caused to change dynamically in response to the needs of the feedback circuit 15. The basic modes of control are; pre-ioniser sweep start-up, the post ionisation ramp-up, full power running condition, first phase dimming, second phase dimming and inverter shut-down. In support of most modes there is the underlying safety protection monitoring that are required to provide general defence against inverter over current, inverter over voltage and mains supply under voltage.

Pre-Ionisation Sweep Start-Up Mode:

The first of the control modes of the present embodiment uses the inverter control means of the ballast controller to control the inverter circuit 7 so as to be greater than the resonance frequency of the ballast circuit 11 by an amount sufficient to prevent operation of the discharge light, and to subsequently reduce the frequency of the inverter output signal until the discharge light becomes operational or a predetermined fault condition limit is reached.

Thus, the inverter control means may be arranged to control the start-up of the discharge light in a manner which avoids simply applying a large instantaneous strike voltage to the discharged light in an attempt to cause the light to ignite. Consequently, the damaging effects of applying such large instantaneous strike voltages upon the circuitry of the ballast controller, the ballast circuit and the components of the discharged light are avoided. Additionally, by sweeping through successively lower frequency values, and thereby gradually increasing the magnitude of the voltage delivered across the discharge light by the ballast circuit, the inverter control means is able to accurately search for the value of the strike voltage which is just enough (but no more) to cause the discharge light to ionise and become conductive.

Referring to FIG. 2, the frequency response one of the ballast circuit 11, as connected to a discharge light 13 in a non-conducting state (i.e. switched off), possesses a resonance at signal frequency ωᵣₑₛ which is less than the signal frequency ω₀ of the AC signal output by the inverter circuit 7 (as controlled by the MPU control unit 17). In accordance with the resonance profile 1 of the ballast circuit 11, the voltage 3 delivered by the ballast circuit 11 to the discharge light 13 in response to an AC inverter output signal of frequency ω₀, is less than the strike voltage Vₛₜᵣᵢₖₑ at which the discharge light 13 would be caused to ionise. The MPU control unit 17 generates control signals which, when input to the inverter circuit 7 cause the frequency of the signal output thereby to steadily reduce in value. The power monitoring unit 15 periodically samples the electrical current passing through the ballast circuit in response to the inverter AC signal input to it, and communicates the sampled values to the MPU control unit 17. The received sample values are compared with predetermined values associated with, or indicative of, the discharge light gas in a conductive state (i.e. switched on, plasma created). Should this comparison indicate that the discharged light has not ionised, the MPU control unit causes the frequency of the inverter AC output to further reduce towards the resonance frequency of the ballast circuit thereby increasing the voltage delivered by the ballast circuit to the discharge light. This process continues until the monitored value of the current passing through the ballast circuit is found to be indicative of the ionisation in the discharge light (sensed current suddenly reduces). At this point the frequency of the AC inverter output signal has reached a value ωₛₜᵣᵢₖₑ which is sufficiently close to the resonance frequency of the ballast circuit as to generate a voltage Vₛₜᵣᵢₖₑ across the discharge light 13 sufficient to cause ionisation thereof. When this condition is reached, the MPU control unit 17 halts further reduction in the frequency of the inverter AC output signal.

Consequently the steady downward sweeping in signal frequency has the benefit of providing a high voltage ramp-up along a gentle slope towards the strike voltage value, thereby reducing stresses on the circuit components of the signal inverter, the ballast circuit and the discharge light. It is to be noted that the value of the strike voltage is effectively the minimum value of voltage at which strike occurs across the particular discharge light 13 used. This is in contradistinction to existing ignition systems which apply an instantaneous and very large strike voltage which is often larger in magnitude than is actually required to cause the discharge light to ignite.

As a safety measure, the MPU control unit is also operable to prevent further reduction in inverter output frequency, during the downward frequency sweep, if it is determined (via the monitor unit 15) that a maximum safe current/voltage has been reached in the sense that exceeding these would damage or destroy the inverter circuit.

An important aspect of this mode is that the operational point at which the discharge light will ionise (strike) is not necessarily the point at which the continuation of the same will operate the light at its maximum energy level. Indeed it is generally the case that following the onset of the strike further operational changes will be required to reach maximum radiate light output from the discharge light.

Post-Ionisation Ramp-Up Mode:

The second of the control modes embodied herein uses the inverter control means of the ballast controller to control the inverter circuit 7 to safely transition the discharge energy from the strike state to the maximum energy state.

Following the ionisation sequence the energy level in the discharge light will be a value suitable to maintain a fully formed plasma but this will not necessarily be at the maximum radiate energy possible. The present embodiment then uses at least the first aspect of the invention to achieve this, the method is as described previously and is the phenomenon discovered by the inventor that the discharge tube can be more efficiently operated if the wave shape of the inverter output is allowed to be a slope-edged square wave as is possible using a inductor that is pushed into its saturation point.

In the current embodiment of the invention this means that the inverter operated through an LC ballast which is set to resonate at approximately 61 KHz. This value is not key but does represent a value that is nether too low so as to cause the passive components to be larger that necessary and not too high that the electromagnetic losses become significant. To keep the operation from excessive current loads the place that is traditionally used to operate the inverter would be slightly above this say 63-65 KHz. At this frequency the discharge light will be operating at the most stable condition as its impedance will “damp” the resonance when voltage across the C element changes these changes will be balanced by the negative impedance of the discharge light itself. However, in the present embodiment this is reversed to below the resonant value. In the case of the current embodiment it is set at 60 HKz. This is not the most efficient frequency only the most stable the inductor is designed to slightly under-run the energy to the light by about 10%.

Full Power Running Mode:

The third of the control modes of the present embodiment uses the inverter control means of the ballast controller to maintain the discharge light at the optimum maximum energy state.

To reach the maximum radiate light output the inverter frequency is reduced fairly quickly, say within 100 mS, to a value were the saturation increases the current through the ballast and light to a predetermined value which represents the maximum current safely allowed. The point at which this occurs is not stable, the discharge light is operating on the verge of entering the 3^{rd} phase of discharge—arc. If the light is allowed to enter the arc phase, current will increase suddenly, the resistance of the plasma drops to a fraction of the glow discharge state and the voltage required to sustain the arc is much lower than the glow required. In this state the super conducting plasma will rapidly damage the electrodes by spot pitting and the conduction element, mercury or xenon, will be absorbed. The very high currents will also overload the inverter and cause destruction of the power driver transistors.

As the stability becomes more critical, as the flat current state is extended, it becomes more and more difficult for the power controller device, the MPU, to maintain the safe margin. It is this that determines the below resonance high efficiency limit of the present embodiment. The closer to the edge of the arc state the more efficient will be the energy conversion. Fluorescent discharge lights are already very efficient at energy conversion and the degree of improvement available is fractions but as any improvement represents lower energy consumption and therefore ultimately lower CO₂ emission to produce the same radiate light output it is a very desirable effect.

The ability to hold the ballast in this region is made possible by maintaining the delivered energy within as constant band as possible. It has already been described how the invention manages this by multiple properties of AC and DC power signals being monitored on a cycle-by-cycle and other aspects of the present invention, the most pertinent being predictive compensation. The overall goal is try to keep the energy within any cycle to better than 2% of any other at that average power state. The process described here is very much affected by temperature within the discharge light itself and time compensation must also be used to allow for the fact that the tube will only run at peak efficiency at around 40° C. (measured at the electrode points) below this temperature and the tube is less stable and the region of improved efficiency is much reduced. This change must also be compensated for when the discharge light is operated in any dimmed level as the heat inside the light will be equally reduced.

In a further enhancement of this aspect the discharge light could be operated in near DC energy drive. Fluorescent lights are operated by AC energy for several reasons not least of which is that the ballast has to be AC to function. On top of this is the fact that if DC were used then the ionisation plasma field would always flow in same direction. This would cause the cathode (negative) end to be darker than the positive (anode) end due to the formation of various so called rings, these in the cathode dark space, the Faraday dark space and the Aston dark space. This would look odd but worse is that the cathode electrode would be eroded at twice the rate so reducing the light life expectancy.

The advantages of operation at DC levels are strong as the conversion rate would be optimal but the disadvantages have always made this a non-starter. However a further possibility using this invention opens up a potential opportunity to operate the light in a slow AC being a virtual DC mode. This aspect being stabilised by high speed rectified PWM which achieves the DC requirements but is direction flipped at low speed to achieve the best discharge light endurance, this process being handled by the intelligent power controller in each direction.

Referring to FIG. 10, the ballast circuit 12 contains an inductor L across which a back-e.m.f. (V_{L}) is generated in response to the a.c. power signal 8 delivered to the ballast circuit by the signal inverter circuit 7. In this embodiment of the present invention, the power monitor means 15 of the power controller is arranged to monitor the inductor voltage V_{L} generated across the inductor L in response to the a.c. power signal. The power monitor 15 periodically samples the inductor voltage V_{L} and delivers the sampled results periodically to the MPU control unit 17 via the communication link 16 between the power monitor and the MPU control unit. This monitoring function of the power monitor means 15 may be in addition to, or instead of, any of the power monitoring functions of the power monitor means discussed above.

In response to the monitored values V_{L} so received, the programming unit MPU 280 of the MPU control unit 17 determines whether or not the received sample value of the inductor voltage is both below a pre-set threshold value and is falling in magnitude. When the programming unit MPU 280 determines both of the latter conditions to be present, it programs each of the first and second PWMs, via respective data links 290 and 300, to generate appropriately timed first and second inverter control signal pulses (320 and 310 respectively) for input to the inverter circuit 7 via separate respective control signal input channels 240 and 250 which collectively define the communications link 18 (see FIG. 7).

The programming unit MPU 280 controls the first PWM 260 to generate a single control pulse, and the second PWM control signal generator 270 to generate a substantially immediately successive single second inverter control signal pulse. In response to receipt of the first and successive second single control signal pulses, the inverter circuit 7 generates a single square-wave excitation pulse which is output concurrently with the a.c. power signal output thereof.

In a further embodiment of the present invention, the power controller additional (or alternatively) includes a light monitoring means 92 arranged to monitor the ambient illumination level 93 in the vicinity of the discharge light 13, and to communicate the monitored illumination levels to the MPU control unit 17 via a communications link 94. In such an embodiment, the MPU control unit 17 is operable to adjust the frequency of the a.c. power signal 8 generated by the inverter circuit 7 so as to adjust the power delivered to, and ultimately radiated by, the discharge light 13 thereby to control the ambient illumination level in the monitored vicinity of that discharge light. This control may be achieved according to control of the first and second PWMs of the MPU control unit 17, as controlled by the programming unit MPU 280 as discussed above.

The MPU control unit 17 may have stored within it any number of predetermined illumination levels (or “dimming” levels) with which the monitored ambient illumination level is compared thereby. The control unit may be, for example, arranged to adjust the power delivered to the discharge light 13 in response to the monitored ambient illumination levels so as to maintain the ambient illumination level at one of the stored “dimming” level values. This auto-dimming feedback control link enables the power controller to cause the discharge light to generate only the required illumination for the vicinity of the discharge light and no more, thereby providing a responsive and energy-efficient discharge lighting system. The power controller may turn off the discharge tube completely when monitored values of ambient illumination indicate that no illumination is required from the discharge light 13. In this condition, the illumination monitor 92 continues to be operational, as does the power controller, such that when ambient illumination levels subsequently fall, and it is determined that illumination from the discharge light 13 is required, the power controller is operable to re-start the discharge light 13 thereby to enable the discharge light to assist in maintaining the required illumination levels. Of course, the discharge light may be ignited and subsequently operated according to any of the methods and apparatus described above in respect of any of the other aspects of the present invention.

A further embodiment of the present invention is now described with reference to FIG. 9 and FIG. 10. Referring to FIG. 10, the power controller includes a d.c. power monitor 95 arranged to monitor the d.c. power 6 input to the inverter circuit 7, and to communicate the monitored values of the d.c. power to the MPU control unit 17 via a communications link 96 connecting the former to the latter. The MPU control unit is arranged to monitor variations in the monitored d.c. power input level, and to vary the frequency of the a.c. power signal 8 generated by the inverter circuit 7 in response to detected variations in the d.c. power input 6. In this way, the MPU control unit 17 is arranged to control the a.c. power signal 8 delivered to the discharge light 13 via the ballast circuit 11 so as to minimise variations in the power supplied to the discharge light resulting from variations within the d.c. monitored power input level.

For example, referring to FIG. 9, there is illustrated a very simplified schematic plot 90 of monitored values of the d.c. signal 6 input to the inverter circuit 7 as monitored by the d.c. monitor unit 95. The d.c. signal 90 is not constant and rises above or falls below a threshold value TH representative of an average d.c. signal level. During a first time interval A, the d.c. level (dashed curve) is below the threshold TH, and subsequently is above that level during the following period B. The d.c. level subsequently is below, above, and once more below the threshold level TH during the subsequent successive time periods C, D and E respectively. Consequently during time periods a, C and E, the d.c. signal level supplied to the inverter circuit 7 and therefore the amplitude of the a.c. power signal 8 generated by and output from the inverter circuit is below the threshold level TH. Conversely during the intermediate periods B and D, the power level input to, and the amplitude of the a.c. signal output from, the inverter circuit 7 is above the threshold value TH. Thus, the periodic variations in the d.c. signal level 90 results in correspondingly periodic variations in the amplitudes of the a.c. power signal a.c. delivered to the discharge light via the ballast circuit 11. These power variations may be visible as variations in the radiant power output of the discharge light 13, and thereby producing a perceptible light output flickering effect.

In order to compensate for the resultant peaks and troughs in power delivered to the discharge light, the MPU control unit 17 is operable to control the frequency of the a.c. signal generated by the inverter circuit 7 in response to variations in the monitored d.c. power input level so as to minimise variations in the power supplied to the discharge light via the ballast circuit. This variation is done according to the frequency response of the ballast circuit whereby the MPU control unit generates inverter control signals which cause the inverter to change the frequency of its a.c. power output signal to recede from the resonance frequency value of the ballast circuit when the d.c. power input is below the threshold value TH, and to cause the inverter a.c. power output signal frequency approach the resonance frequency when the d.c. power exceeds the threshold value TH. In the present example, the inverter circuit 7 is controlled to operate at frequencies below the resonance frequency of the ballast circuit 11 such that during the time intervals A, C and E, the inverter circuit is controlled to generate an a.c. power signal of relatively lower frequency (i.e. the frequency recedes from the resonance frequency value, which is higher than the a.c. signal frequency value). Conversely, during the time intervals B and D when the d.c. power level is above the threshold value TH the inverter output signal frequency is caused to increase and to move towards the resonance frequency value.

In this way, when d.c. power input levels are too large, the inverter output signal is caused to move towards the resonance peak associated with the ballast circuit frequency response. Conversely, while the d.c. power input level is too low, the inverter output signal frequency is caused to move away from the resonance frequency profile. This reduces and increases the power delivered to the discharge light 13 via the ballast circuit 11 respectively thereby compensating for the oppositely-directed power variations in the input d.c. power level.

The MPU control unit 17 is arranged to determine the oscillation period of each successive half-cycle of the variations in the input d.c. power level. That is to say, the control unit determines the duration and location of the successive time intervals A, B, C, D and E. The MPU control unit is operable to vary the frequency of the inverter output signal so as to affect the appropriate change in power delivered to the discharge light 13 during the forthcoming cycle in the d.c. signal variations. This is illustrated in the waveform 91 of FIG. 9.

FIG. 6 schematically illustrates the output characteristics of a discharge light driven according to prior art power control techniques and apparatus, together with the operating characteristics of the same discharge light when driven according to power control techniques and apparatus of the present invention at a.c. power signal frequencies below the ballast resonance frequency.

Two sets of plots are illustrated in FIG. 6, the upper set comprising the voltage across (V₁), current through (I₁), and light output of (X₁) a discharge light driven according to a Philips BTA 58L31 ballast together with a phase correction capacitor fitted across an Osram L58W/835 white fluorescent discharge light.

The lower set of plots illustrates the voltage (V₂) generated across, the current (I₂) passing through, and the light output (bounded by lines XU₂ and XL₂) produced by the same Osram fluorescent discharge light when driven according to power control methods and apparatus of the present invention. Here, the fluorescent light was driven at frequencies below ballast resonance as discussed above with reference to FIGS. 1 and 5. The drive frequency was controlled according to variations in d.c. power input to the driving signal inverter as described above with reference to FIG. 10. Control signal pulses were used to control the drive frequency as discussed with reference to FIG. 8.

As can be seen from the upper set of plots of FIG. 6, the phase of the current I₁ passing through the fluorescent light in question still lags the phase of the voltage V₁ generated across that fluorescent light. This is so in spite of the presence of a phase correction capacitor having been employed with the Philips ballast.

The waveform of both the voltage V₁ and the current I₁ is substantially periodic and substantially continuously varying. Consequently, the measured light output X₁ was also found to be broadly periodic in form possessing a dominant low frequency component with a number of very high frequency components superimposed upon the dominant low frequency component. The low frequency component produces a flickering effect.

Conversely, the lower set of plots illustrates that the discharge light voltage V₂ and current I₂ are not only brought into phase according to the present invention, but that each also shows much less distortion by virtue of the fact that the load is substantially constant across each cycle of those waveforms. The light output X₂ has had substantially removed from it the dominant low frequency component present within the light output waveform X₁. Consequently, predominantly only the high frequency light output components remain within the light output signal X₂ such that the light output oscillates rapidly between the upper output limit XU₂ and the lower limit XL₂ with little or no low frequency oscillations therein. Consequently, the light output X₂ shows very little or substantially no flicker. It is to be noted that the waveform of the discharge light current I₂ is substantially flat during each “saturation period” T_{S} during which the current delivered to the discharge light is substantially constant. Additionally, the proportion of each cycle of the discharge light current I₂ during which the current undergoes significant changes in magnitude (i.e. the periods in between each successive “saturation period”) is relatively small, thereby reducing visible flicker in the light output of the fluorescent light.

The steady state value of V₁ and V₂ was 230 volts (a.c.). The corresponding steady state values of I₁ and I₂ were found to be 423 mA a.c. and 226 mA a.c. respectively. The d.c. value of the light outputs X₁ and X₂ were substantially equal. Thus, the fluorescent light when driven according to the power control methods and apparatus of the present invention was found to operate at a significantly lower power rating, produced significantly less flicker.

It is to be noted that in practice a time lag will exist between the implementation of an inverter frequency change and the effect of that change becoming apparent upon the power delivered to the discharge light via the ballast circuit. The dotted DC signal curve of FIG. 9 is purely for illustrative purposes, while the solid curve 90 of FIG. 9 more accurately reflects the relative phases (lag accounted for) between inverter output and input signals.

It is to be appreciated that modifications to or variants of any one of the embodiments described above, such as would be readily apparent to the skilled person, may be made without departing from the scope of the invention.

1-49. (canceled)

50. A method for controlling the power delivered to a discharge light by an alternating (AC) power signal via a ballast circuit which resonates at a predetermined value of the frequency of said alternating power signal, the method including:
maintaining the value of the frequency of said alternating power signal to be always less than said predetermined value after the discharge light has struck and incrementally changing the frequency of the AC power signal to maximise or stabilise the power delivered to the discharge light, wherein the frequency increments are controlled so as to not exceed a predetermined maximum increment value selected to prevent plasma drop-out in response to an increment in said frequency.

51. A method according to claim 50 including causing the frequency of the power signal to approach the arc frequency at which the discharge light enters the third discharge state, in which discharge the light enters an arc discharge condition, and controlling the power signal frequency to prevent entry into that state.

52. A method according to claim 50 including controlling the frequency of the power signal so as to reduce the difference between the frequency of the power signal and the arc frequency, in which discharge the light enters an arc discharge condition, as much as possible without causing the discharge light to enter an arc discharge state.

53. A method according to claim 50 including varying the frequency of the power signal according to a measure of the power delivered to, or converted in to radiant energy by, the discharge light.

54. A method according to claim 53 including monitoring the amount of power converted by the discharge light or delivered to it by the ballast circuit, and adjusting the alternating power signal in response to variations in the monitored power so as to maximise the power delivered to or converted by the discharge light.

55. A method according to claim 50 including adjusting the frequency of the alternating power signal so as to maximise the proportion of the power in the power signal received by the ballast circuit which is delivered to the discharge light thereby.

56. A method according to claim 50 including decreasing the frequency of the AC power signal in response to decreases in the delivered power thereby to increase the power delivered to the discharge light.

57. A method according to claim 50 including adjusting the AC power signal frequency when responding to variations in the delivered power so as to cause a stabilisation in delivered power.

58. A method according to claim 57 including increasing the frequency of the AC power signal in response to increases in the delivered power, and decreasing the frequency of the AC power signal in response to decreases in the delivered power, thereby to stabilise the delivered power.

59. A method according to claim 50 including monitoring the value of a selected property of the alternating power signal: as input to the ballast circuit; and/or, as present within the ballast circuit; and/or, as delivered to the discharge light, and deriving from the monitored value of the selected property a measure of the power delivered to the discharge light.

60. A method according to claim 59 in which said selected property is the value of the electrical currents both as present within the ballast circuit and as concurrently delivered to the discharge light.

61. A method according to claim 55 including sampling values of said selected property of the alternating power signal once within separate successive sampling periods, wherein each sampling period is no greater in duration than one half of the duration of a single cycle of said alternating power signal.

62. A method according to claim 51 including adjusting any one or more of the frequency, amplitude, or phase of the alternating power signal when adjusting that signal in response to variations in the delivered power.

63. A method according to claim 50 including maintaining the frequency of the AC power signal at a value sufficiently low that during at least a part of a cycle of the AC power signal an inductor means of the ballast circuit is caused to saturate, whereby the magnitude of the back-e.m.f. induced thereby is less than a predetermined threshold value during said part of said cycle.

64. A power controller for controlling the power delivered to a discharge light by an alternating (AC) power signal via a ballast circuit which resonates at a predetermined value of the frequency of said alternating power signal, including:
a power control means arranged to control the AC power signal to maintain the value of the frequency of said AC power signal to be always less than said predetermined value after the discharge light has struck to incrementally change the frequency of the AC power signal to maximise or stabilise the power delivered to the discharge light, wherein the frequency increments are controlled so as to not exceed a predetermined maximum increment value selected to prevent plasma drop-out in response to an increment in said frequency.

65. A power controller according to claim 64 in which the power control means is arranged to vary the frequency of the power signal to approach the frequency at which the discharge light enters the third discharge state, in which discharge the light enters an arc discharge condition, and to control the power signal frequency to prevent entry into that state.

66. A power controller according to claim 64 in which the power control means is arranged to control the frequency of the power signal so as to reduce the difference between the frequency of the power signal and the arc frequency, at which discharge the light would enter an arc discharge condition, as much as possible without causing the discharge light to enter an arc discharge state.

67. A power controller according to claim 64 in which the power control means is arranged to vary the frequency of the power signal according to a measure of the power delivered to, or converted in to radiant energy by, the discharge light.

68. A power controller according to claim 64 in which the power control means is arranged to monitor the amount of power converted by the discharge light, or delivered to it by the ballast circuit, and to adjust the AC power signal in response to variations in the monitored power so as to maximise the power converted by, or delivered to, the discharge light.

69. A power controller according to claim 64 arranged to adjust the frequency of the alternating power signal so as to maximise the proportion of the power in the power signal received by the ballast circuit which is delivered to the discharge light thereby.

70. A power controller according to claim 65 arranged to decrease the frequency of the AC power signal in response to decreases in the delivered power thereby to increase the power delivered to the discharge light.

71. A power controller according to claim 64 arranged to adjust the AC power signal frequency when responding to variations in the delivered power so as to cause a stabilisation in delivered power.

72. A power controller according to claim 71 arranged to increase the frequency of the AC power signal in response to increases in the delivered power, and decrease the frequency of the AC power signal in response to decreases in the delivered power, thereby to stabilise the delivered power.

73. A power controller according to claim 64 in which the power control means includes power monitor means arranged to monitor the value of a selected property of the AC power signal: as input to the ballast circuit; and/or, as delivered to the discharge light, and to derive from the monitored value of the selected property a measure of the power delivered to the discharge light.

74. A power controller according to claim 73 in which said selected property is the value of the electrical current delivered to the discharge light.

75. A power controller according to claim 64 in which the power monitor means is arranged to sample values of said selected property of the AC power signal once within separate successive sampling periods, wherein each sampling period is no greater in duration than the one half of the duration of a single cycle of said AC power signal.

76. A power controller according to claim 64 in which the power control means is arranged to adjust any one or more of the frequency, amplitude, or phase of the AC power signal when adjusting that signal in response to variations in the delivered power.

77. A power controller according to claim 64 in which the power control means is arranged to maintain the frequency of the AC power signal at a value sufficiently low that during at least a part of a cycle of the AC power signal an inductor means of the ballast circuit is caused to saturate, whereby the magnitude of the back-e.m.f. induced thereby is less than a predetermined threshold value during said part of said cycle.

78. A power controller according to claim 64 wherein an inverter means is arranged to receive a DC power input signal and to generate said alternating (AC) power signal therefrom for powering the discharge light via a ballast circuit, wherein the power control means includes an inverter control means arranged to generate inverter control signals for controlling said inverter so as to control the AC power signal generated thereby.

79. A power controller according to claim 78 wherein said power control means includes said inverter means.
